(19) United States
(12) Patent Application Publication
(10) Pub. No.: US 2004/0240420 A1
(43) Pub. Date: Dec. 2, 2004

(54) Front end module and high-frequency functional module

(75) Inventor: Shinya Nakai, Tokyo (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 10/774,606

(22) Filed: Feb. 10, 2004

(30) Foreign Application Priority Data
Feb. 14, 2003 (JP) 2003-37474

(51) Int. Cl. H04B 7/216

(52) U.S. Cl. 370/342; 370/441

(57) ABSTRACT

A front end module comprises a diplexer, a high frequency switch and a duplexer. The diplexer has a first port connected to an antenna, a second port for receiving and outputting GSM signals, and a third port for receiving and outputting W-CDMA signals. The high frequency switch is connected to the second port and separates GSM transmission signals and reception signals from each other. The duplexer is connected to the third port and separates W-CDMA transmission signals and reception signals from each other. The duplexer includes two acoustic wave elements. A single multi-layer substrate for integration is used to integrate the diplexer, the high frequency switch and the duplexer.

### BACKGROUND OF THE INVENTION

1. Field of the Invention

The present invention relates to a front end module and a high frequency functional module for processing transmission signals and reception signals in a communications device such as a cellular phone.

2. Description of the Related Art

Third-generation cellular phones have been introduced and it is getting required that such phones have not only the speech function but also the high-speed data communications function. Therefore, in various countries, adoption of a variety of multiplexing systems for achieving high-speed data communications is considered. In the current situation, however, it is difficult to unify the multiplexing systems. Consequently, it is required that the cellular phones be provided for multiple modes (systems) and multiple bands.

In Europe, for example, dual-band cellular phones operable under the global system for mobile communications (GSM) and the digital cellular system (DCS) have been used in the entire region. Each of the GSM and the DCS is a time division multiple access system. In Europe, as the third-generation cellular phones, it is expected that dual-mode, triple-band cellular phones are adopted, which are operable under the wideband code division multiple access (W-CDMA) capable of implementing a high data communication speed (2 Mbps, for example), in addition to the above-mentioned two systems.

If new functions as described above are added to the cellular phones, the circuits are more complicated and the number of components increases. Higher-density mounting techniques are thus required for the cellular phones. Under such a circumstance, it is necessary to achieve a reduction in size and weight, and higher combination and integration of the components for the high frequency circuits inside the cellular phones to reduce the mounting space.

A front end module for the dual-band cellular phones operable in the GSM and DCS has been already known and practically utilized, as disclosed in the Published Unexamined Japanese Patent Application Heisei 11-225088 (1999). This front end module separates the frequency band corresponding to the GSM and the frequency band corresponding to the DCS from each other through the use of a diplexer, for example, and separates transmission signals and reception signals from each other through the use of a high frequency switch, for example.

Here, designing of a front end module for the dual-mode, triple-band cellular phones operable in the GSM, the DCS and the W-CDMA is considered. It is required that this front end module separate the frequency bands corresponding to the three systems from one another and separate transmission signals and reception signals from each other for the respective systems. However, the W-CDMA is a code division multiple access system, so that it is required that the transmitting function and the receiving function both operate at any time. Consequently, it is impossible to separate transmission signals and reception signals from each other in a time division manner through the use of a high frequency switch in the W-CDMA system. Therefore, to separate transmission and reception signals from each other in the W-CDMA, a duplexer that separates transmission signals and reception signals from each other according to the difference in frequency is used, as for the first-generation cellular phones of the analog system.

Many of the duplexers for the W-CDMA currently used are those of coaxial dielectric type that have a small insertion loss. However, the coaxial-dielectric duplexers are large and heavy so that they are not suitable for reducing the size and weight of the front end modules. In addition, these duplexers are made of different materials and have a different configuration from the conventional front end modules, so that they are not suitable for combination and integration with the front end modules, either.

### OBJECTS AND SUMMARY OF THE INVENTION

It is a first object of the invention to provide a front end module that is operable in the time division multiple access system and the code division multiple access system and easily achieves a reduction in size and weight, and higher combination and integration of components.

It is a second object of the invention to provide a high frequency functional module that includes a duplexer for separating transmission signals and reception signals from each other and easily achieves a reduction in size and weight, and higher combination and integration of components.

A first front end module of the invention is a module for processing transmission signals and reception signals of a time division multiple access system and transmission signals and reception signals of a code division multiple access system. The front end module comprises: a first separating means connected to an antenna and separating the transmission signals and the reception signals of the time division multiple access system from the transmission signals and the reception signals of the code division multiple access system; a second separating means connected to the first separating means and separating the transmission signals of the time division multiple access system from the reception signals of the time division multiple access system; a duplexer connected to the first separating means, including two acoustic wave elements each of which functions as a filter, and separating the transmission signals of the code division multiple access system from the reception signals of the code division multiple access system; and a single multi-layer substrate for integrating the first separating means, the second separating means and the duplexer.

According to the first front end module of the invention, the first separating means separates the transmission signals and the reception signals of the time division multiple access system from the transmission signals and the reception signals of the code division multiple access system. The second separating means separates the transmission signals of the time division multiple access system from the reception signals of the time division multiple access system. The duplexer including the two acoustic wave elements separates the transmission signals of the code division multiple access system from the reception signals of the code division multiple access system. The single multi-layer substrate is used to integrate the first separating means, the second separating means and the duplexer. The acoustic wave elements are elements utilizing acoustic waves, which may be the ones utilizing surface acoustic waves or the ones utilizing bulk acoustic waves.

The first front end module of the invention may further comprise: a filter connected to the second separating means and allowing the transmission signals of the time division multiple access system to pass through this filter; a filter connected to the second separating means and allowing the reception signals of the time division multiple access system to pass through this filter; and a filter connected to the duplexer and allowing the reception signals of the code division multiple access system to pass through this filter. In addition, the multi-layer substrate may be used to further integrate the filters.

The first front end module of the invention may further comprise a power amplifier for amplifying the transmission signals of the time division multiple access system and a power amplifier for amplifying the transmission signals of the code division multiple access system. In addition, the multi-layer substrate may be used to further integrate the power amplifiers.

The first front end module of the invention may further comprise the antenna and the multi-layer substrate may be used to further integrate the antenna.

According to the first front end module of the invention, the duplexer may incorporate a chip or two chips including the acoustic wave elements and a mounting board on which the chip or chips are mounted, the mounting board may include components of the duplexer except the acoustic wave elements, and the duplexer may be mounted on the multi-layer substrate.

According to the first front end module of the invention, the duplexer may incorporate a chip or two chips including the acoustic wave elements and mounted on the multi-layer substrate, and the multi-layer substrate may include components of the duplexer except the acoustic wave elements.

According to the first front end module of the invention, the duplexer may incorporate a chip or two chips including the acoustic wave elements and a mounting board or two mounting boards on which the chip or chips are mounted, the chip or chips and the mounting board or boards may be mounted on the multi-layer substrate, and the multi-layer substrate may include components of the duplexer except the acoustic wave elements.

A second front end module of the invention is a module for processing first transmission signals and first reception signals of a time division multiple access system included in a first frequency band, second transmission signals and second reception signals of a time division multiple access system included in a second frequency band, and third transmission signals and third reception signals of a code division multiple access system included in a third frequency band.

The second front end module of the invention comprises: a first separating means connected to an antenna and separating the first transmission signals and the first reception signals, the second transmission signals and the second reception signals, and the third transmission signals and the third reception signals from one another; a second separating means connected to the first separating means and separating the first transmission signals from the first reception signals; a third separating means connected to the first separating means and separating the second transmission signals from the second reception signals; a duplexer connected to the first separating means, including two acoustic wave elements each of which functions as a filter, and separating the third transmission signals from the third reception signals; and a single multi-layer substrate for integrating the first separating means, the second separating means, the third separating means and the duplexer.

According to the second front end module of the invention, the first separating means separates the first transmission signals and the first reception signals, the second transmission signals and the second reception signals, and the third transmission signals and the third reception signals from one another. The second separating means separates the first transmission signals from the first reception signals. The third separating means separates the second transmission signals from the second reception signals. The duplexer including the two acoustic wave elements separates the third transmission signals from the third reception signals. The single multi-layer substrate is used to integrate the first separating means, the second separating means, the third separating means and the duplexer.

The second front end module of the invention may further comprise: a filter connected to the second separating means and allowing the first transmission signals to pass through this filter; a filter connected to the second separating means and allowing the first reception signals to pass through this filter; a filter connected to the third separating means and allowing the second transmission signals to pass through this filter; a filter connected to the third separating means and allowing the second reception signals to pass through this filter; and a filter connected to the duplexer and allowing the third reception signals to pass through this filter. In addition, the multi-layer substrate may be used to further integrate the filters.

The second front end module of the invention may further comprise a power amplifier for amplifying the first transmission signals, a power amplifier for amplifying the second transmission signals, and a power amplifier for amplifying the third transmission signals. In addition, the multi-layer substrate may be used to further integrate the power amplifiers.

The second front end module of the invention may further comprise the antenna and the multi-layer substrate may be used to further integrate the antenna.

According to the second front end module of the invention, the duplexer may incorporate a chip or two chips including the acoustic wave elements and a mounting board on which the chip or chips are mounted, the mounting board may include components of the duplexer except the acoustic wave elements, and the duplexer may be mounted on the multi-layer substrate.

According to the second front end module of the invention, the duplexer may incorporate a chip or two chips including the acoustic wave elements and mounted on the multi-layer substrate, and the multi-layer substrate may include components of the duplexer except the acoustic wave elements.

According to the second front end module of the invention, the duplexer may incorporate a chip or two chips including the acoustic wave elements and a mounting board or two mounting boards on which the chip or chips are mounted, the chip or chips and the mounting board or boards may be mounted on the multi-layer substrate, and the multi-layer substrate may include components of the duplexer except the acoustic wave elements.

A third front end module of the invention is a module for processing first transmission signals and first reception signals of a time division multiple access system included in a first frequency band, second transmission signals and second reception signals of a time division multiple access system included in a second frequency band, third transmission signals and third reception signals of a code division multiple access system included in a third frequency band, and fourth transmission signals and fourth reception signals of a code division multiple access system included in a fourth frequency band.

The third front end module of the invention comprises: a first separating means connected to an antenna and separating the first transmission signals and the first reception signals, the second transmission signals and the second reception signals, the third transmission signals and the third reception signals, and the fourth transmission signals and the fourth reception signals from one another; a second separating means connected to the first separating means and separating the first transmission signals from the first reception signals; a third separating means connected to the first separating means and separating the second transmission signals from the second reception signals; a first duplexer connected to the first separating means, including two first acoustic wave elements each of which functions as a filter, and separating the third transmission signals from the third reception signals; a second duplexer connected to the first separating means, including two second acoustic wave elements each of which functions as a filter, and separating the fourth transmission signals from the fourth reception signals; and a single multi-layer substrate for integrating the first separating means, the second separating means, the third separating means, the first duplexer and the second duplexer.

According to the third front end module of the invention, the first separating means separates the first transmission signals and the first reception signals, the second transmission signals and the second reception signals, the third transmission signals and the third reception signals, and the fourth transmission signals and the fourth reception signals from one another. The second separating means separates the first transmission signals from the first reception signals. The third separating means separates the second transmission signals from the second reception signals. The first duplexer including the two first acoustic wave elements separates the third transmission signals from the third reception signals. The second duplexer including the two second acoustic wave elements separates the fourth transmission signals from the fourth reception signals. The single multi-layer substrate for integrating is used to integrate the first separating means, the second separating means, the third separating means, the first duplexer and the second duplexer.

The third front end module of the invention may further comprise: a filter connected to the second separating means and allowing the first transmission signals to pass through this filter; a filter connected to the second separating means and allowing the first reception signals to pass through this filter; a filter connected to the third separating means and allowing the second transmission signals to pass through this filter; a filter connected to the third separating means and allowing the second reception signals to pass through this filter; a filter connected to the first duplexer and allowing the third reception signals to pass through this filter; and a filter connected to the second duplexer and allowing the fourth reception signals to pass through this filter. In addition, the multi-layer substrate may be used to further integrate the filters.

The third front end module of the invention may further comprise: a power amplifier for amplifying the first transmission signals; a power amplifier for amplifying the second transmission signals; a power amplifier for amplifying the third transmission signals; and a power amplifier for amplifying the fourth transmission signals. In addition, the multi-layer substrate may be used to further integrate the power amplifiers.

The third front end module of the invention may further comprise the antenna, and the multi-layer substrate may be used to further integrate the antenna.

According to the third front end module of the invention, the first duplexer may incorporate a first chip or two first chips including the first acoustic wave elements and a first mounting board on which the first chip or chips are mounted, and the first mounting board may include components of the first duplexer except the first acoustic wave elements. The second duplexer may incorporate a second chip or two second chips including the second acoustic wave elements and a second mounting board on which the second chip or chips are mounted, and the second mounting board may include components of the second duplexer except the second acoustic wave elements. The first and second duplexers may be mounted on the multi-layer substrate.

According to the third front end module of the invention, the first duplexer may incorporate a first chip or two first chips including the first acoustic wave elements and mounted on the multi-layer substrate. The second duplexer may incorporate a second chip or two second chips including the second acoustic wave elements and mounted on the multi-layer substrate. The multi-layer substrate may include components of the first duplexer except the first acoustic wave elements and components of the second duplexer except the second acoustic wave elements.

According to the third front end module of the invention, the first duplexer may incorporate a first chip or two first chips including the first acoustic wave elements and a first mounting board or two first mounting boards on which the first chip or chips are mounted, and the first chip or chips and the first mounting board or boards may be mounted on the multi-layer substrate. The second duplexer may incorporate a second chip or two second chips including the second acoustic wave elements and a second mounting board or two second mounting boards on which the second chip or chips are mounted, and the second chip or chips and the second mounting board or boards may be mounted on the multi-layer substrate. The multi-layer substrate may include components of the first duplexer except the first acoustic wave elements and components of the second duplexer except the second acoustic wave elements.

A first high frequency functional module of the invention comprises: a duplexer including two acoustic wave elements each of which functions as a filter and separating transmission signals from reception signals; and a single multi-layer substrate for integrating the duplexer. The duplexer incorporates a chip or two chips including the acoustic wave elements and mounted on the multi-layer substrate. The multi-layer substrate includes at least part of components of the duplexer except the acoustic wave elements, and/or at least part of a circuit connected to the duplexer.

According to the first high frequency functional module of the invention, the duplexer incorporates the chip or chips including the acoustic wave elements and mounted on the multi-layer substrate. The multi-layer substrate includes at least part of components of the duplexer except the acoustic wave elements, and/or at least part of the circuit connected to the duplexer.

A second high frequency functional module of the invention comprises: a duplexer including two acoustic wave elements each of which functions as a filter and separating transmission signals from reception signals; and a single multi-layer substrate for integrating the duplexer. The duplexer incorporates a chip or two chips including the acoustic wave elements and a mounting board or two mounting boards on which the chip or chips are mounted. The chip or chips and the mounting board or boards are mounted on the multi-layer substrate. The multi-layer substrate includes at least part of components of the duplexer except the acoustic wave elements, and/or at least part of a circuit connected to the duplexer.

According to the second high frequency functional module of the invention, the duplexer incorporates the chip or chips including the acoustic wave elements and the mounting board or boards on which the chip or chips are mounted, and the chip or chips and the mounting board or boards are mounted on the multi-layer substrate. The multi-layer substrate includes at least part of components of the duplexer except the acoustic wave elements, and/or at least part of the circuit connected to the duplexer.

According to the invention, the high frequency functional module is a module including at least a duplexer and having a function of processing high frequency signals including transmission signals and reception signals.

Other and further objects, features and advantages of the invention will appear more fully from the following description.

### BRIEF DESCRIPTION OF THE DRAWINGS

FIG. 1 is a block diagram illustrating an example of a high frequency circuit of a cellular phone including a front end module of a first embodiment of the invention.

FIG. 2 is a schematic diagram illustrating an example of the circuit configuration of the diplexer of FIG. 1.

FIG. 3 is a schematic diagram illustrating an example of the circuit configuration of the high frequency switch of FIG. 1.

FIG. 4 is a block diagram illustrating an example of the circuit configuration of the duplexer of FIG. 1.

FIG. 5 is a schematic diagram illustrating an example of the circuit configuration of the duplexer of FIG. 1 and a matching circuit connected thereto.

FIG. 6 is a schematic diagram illustrating an example of the circuit configuration of the low-pass filter of FIG. 1.

FIG. 7 is a schematic diagram illustrating an example of the circuit configuration of the coupler of FIG. 1.

FIG. 8 is a schematic diagram illustrating an example of the circuit configuration of the power amplifier of FIG. 1.

FIG. 9 is a cross-sectional view illustrating a first example of the structure of the duplexer of FIG. 1.

FIG. 10 is a cross-sectional view illustrating a second example of the structure of the duplexer of FIG. 1.

FIG. 11 is a cross-sectional view illustrating a third example of the structure of the duplexer of FIG. 1.

FIG. 12 is a block diagram illustrating a high frequency circuit of a cellular phone including a front end module of a first modification example of the first embodiment of the invention.

FIG. 13 is a block diagram illustrating a high frequency circuit of a cellular phone including a front end module of a second modification example of the first embodiment of the invention.

FIG. 14 is a block diagram illustrating a high frequency circuit of a cellular phone including a front end module of a third modification example of the first embodiment of the invention.

FIG. 15 is a cross-sectional view illustrating an example of arrangement of the power amplifier of the front end module of FIG. 14.

FIG. 16 is a block diagram illustrating an example of a high frequency circuit of a cellular phone including a front end module of a second embodiment of the invention.

FIG. 17 is a block diagram illustrating a high frequency circuit of a cellular phone including a front end module of a first modification example of the second embodiment of the invention.

FIG. 18 is a top view illustrating an example of the structure of the front end module of FIG. 17.

FIG. 19 is a cross-sectional view of the front end module of FIG. 18 taken along line A-A.

FIG. 20 is a block diagram illustrating a high frequency circuit of a cellular phone including a front end module of a second modification example of the second embodiment of the invention.

FIG. 21 is a block diagram illustrating an example of a high frequency circuit of a cellular phone including a front end module of a third embodiment of the invention.

FIG. 22 is a block diagram illustrating a high frequency circuit of a cellular phone including a front end module of a first modification example of the third embodiment of the invention.

FIG. 23 is a block diagram illustrating a high frequency circuit of a cellular phone including a front end module of a second modification example of the third embodiment of the invention.

FIG. 24 is a perspective view illustrating a first example of the structure of an antenna of a fourth embodiment of the invention.

FIG. 25 is a perspective view illustrating a second example of the structure of the antenna of the fourth embodiment of the invention.

FIG. 26 is a block diagram illustrating an example of a high frequency circuit of a cellular phone including a front end module of a fifth embodiment of the invention.

FIG. 27 is a block diagram illustrating the duplexer of FIG. 26.

### DESCRIPTION OF PREFERRED EMBODIMENTS

Preferred embodiments of the invention will now be described in detail with reference to the accompanying drawings.

[First Embodiment]

A front end module of a first embodiment of the invention will now be described. The front end module of the embodiment is a module that is operable in the GSM as a time division multiple access system and the W-CDMA as a code division multiple access system and that processes transmission signals and reception signals of these systems. The frequency band of transmission signals of the GSM is 880 to 915 MHz. The frequency band of reception signals of the GSM is 925 to 960 MHz. The frequency band of transmission signals of the W-CDMA is 1920 to 1990 MHz. The frequency band of reception signals of the W-CDMA is 2110 to 2180 MHz.

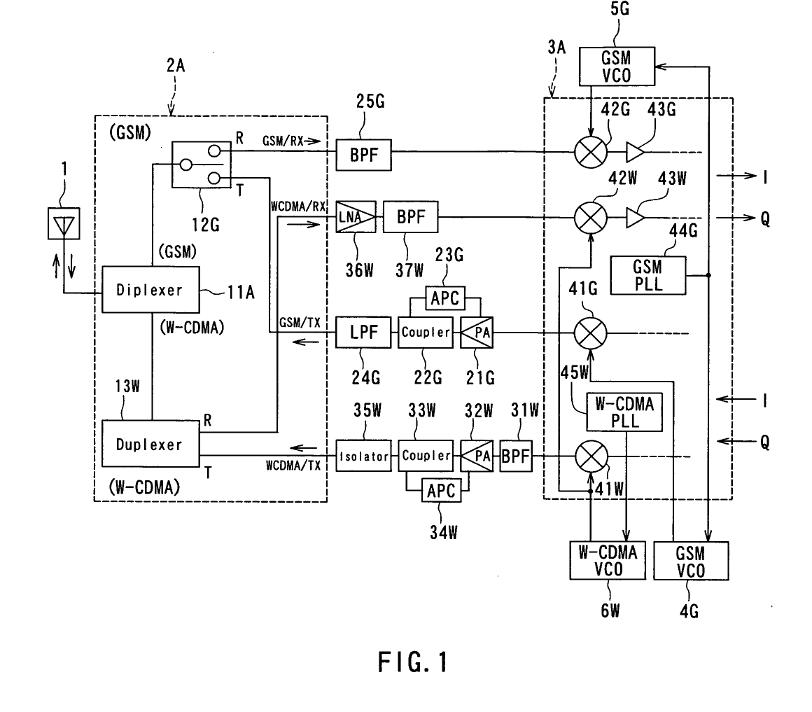

Reference is now made to FIG. 1 to describe an example of a high frequency circuit of a cellular phone including the front end module of the embodiment. The high frequency circuit of FIG. 1 comprises an antenna 1, the front end module 2A of the embodiment connected to the antenna 1, and an integrated circuit 3A that mainly performs signal modulation and demodulation. The high frequency circuit further comprises two voltage controlled oscillators (indicated as GSM VCO in the drawings) 4G and 5G for the GSM, and a voltage controlled oscillator (indicated as W-CDMA VCO in the drawings) 6W for the W-CDMA. The voltage controlled oscillators 4G, 5G and 6W are connected to the integrated circuit 3A.

The high frequency circuit further comprises: a band-pass filter (indicated as BPF in the drawings) 25G having an input connected to the front end module 2A and an output connected to the integrated circuit 3A; a low-noise amplifier (indicated as LNA in the drawings) 36W having an input connected to the front end module 2A; and a band-pass filter 37W having an input connected to an output of the low-noise amplifier 36W and an output connected to the integrated circuit 3A. Each of the band-pass filters 25G and 37W is made up of an acoustic wave element.

The high frequency circuit further comprises: a power amplifier (indicated as PA in the drawings) 21G having an input connected to the integrated circuit 3A; a coupler 22G having an input connected to an output of the power amplifier 21G; an automatic power control circuit (indicated as APC in the drawings) 23G for controlling the power amplifier 21G based on the output of the coupler 22G, so that the output gain of the power amplifier 21G is made constant; and a low-pass filter (indicated as LPF in the drawings) 24G having an input connected to an output of the coupler 22G and an output connected to the front end module 2A.

The high frequency circuit further comprises: a band-pass filter 31W having an input connected to the integrated circuit 3A; a power amplifier 32W having an input connected to an output of the band-pass filter 31W; a coupler 33W having an input connected to an output of the power amplifier 32W; an automatic power control circuit 34W for controlling the power amplifier 32W based on the output of the coupler 33W, so that the output gain of the power amplifier 32W is made constant; and an isolator 35W having an input connected to an output of the coupler 33W and an output connected to the front end module 2A. The band-pass filter 31W is made up of an acoustic wave element.

The front end module 2A will now be described in detail. The front end module 2A comprises a diplexer 11A, a high frequency switch 12G and a duplexer 13W. The diplexer 11A has first to third ports. The first port is connected to the antenna 1. The second port is designed to receive and output GSM signals. The third port is designed to receive and output W-CDMA signals.

The second port of the diplexer 11A is connected to a movable contact of the high frequency switch 12G. The high frequency switch 12G has two fixed contacts one of which (the one indicated with R) is connected to the input of the band-pass filter 25G. The other one (the one indicated with T) of the fixed contacts of the high frequency switch 12G is connected to the output of the low-pass filter 24G. The third port of the diplexer 11A is connected to the duplexer 13W.

The duplexer 13W has a common terminal, a reception terminal (the one indicated with R) and a transmission terminal (the one indicated with T). The common terminal of the duplexer 13W is connected to the third port of the diplexer 11A. The reception terminal of the duplexer 13W is connected to the input of the low-noise amplifier 36W. The transmission terminal of the duplexer 13W is connected to the output of the isolator 35W.

The diplexer 11A separates transmission signals and reception signals of the GSM and transmission signals and reception signals of the W-CDMA from each other, according to the frequency of the signals. To be specific, the diplexer 11A outputs from the first port the GSM transmission signals inputted to the second port and the W-CDMA transmission signals inputted to the third port, outputs from the second port the GSM reception signals inputted to the first port, and outputs from the third port the W-CDMA reception signals inputted to the first port. The diplexer 11A corresponds to the first separating means of the invention.

The high frequency switch 12G separates GSM transmission signals and GSM reception signals from each other. To be specific, the high frequency switch 12G outputs from the one of the fixed contacts the GSM reception signals (indicated as GSM/RX in the drawings) inputted to the movable contact, and outputs from the movable contact the GSM transmission signals (indicated as GSM/TX in the drawings) inputted to the other one of the fixed contacts. The high frequency switch 12G corresponds to the second separating means of the invention. p The duplexer 13 separates W-CDMA transmission signals and W-CDMA reception signals from each other, according to the difference in frequency. To be specific, the duplexer 13W outputs from the reception terminal the W-CDMA reception signals (indicated as WCDMA/RX in the drawings) inputted to the common terminal, and outputs from the common terminal the W-CDMA transmission signals (indicated as WCDMA/TX in the drawings) inputted to the transmission terminal.

The integrated circuit 3A will now be described. The integrated circuit 3A receives an input signal of the baseband made up of an in-phase component signal (hereinafter called an I signal) and a quadrature component signal (hereinafter called a Q signal), and outputs an output signal of the baseband made up of an I signal and a Q signal.

The integrated circuit 3A comprises: a mixer 42G having an input connected to the output of the band-pass filter 25G; an amplifier 43G having an input connected to an output of the mixer 42G; a mixer 42W having an input connected to the output of the band-pass filter 37W; an amplifier 43W having an input connected to an output of the mixer 42W; a mixer 41G having an output connected to the input of the power amplifier 21G; and a mixer 41W having an output connected to the input of the band-pass filter 31W. The mixer 42G is connected to the voltage controlled oscillator 5G. The mixer 42W is connected to the voltage controlled oscillator 6W. The mixer 41G is connected to the voltage controlled oscillator 4G. The mixer 41W is connected to the voltage controlled oscillator 6W.

The integrated circuit 3A further comprises a phase-locked loop circuit (indicated as GSM PLL in the drawings) 44G for the GSM and a phase-locked loop circuit (indicated as W-CDMA PLL in the drawings) 45W for the W-CDMA. The phase-locked loop circuit 44G is connected to the voltage controlled oscillators 4G and 5G. The phase-locked loop circuit 45W is connected to the voltage controlled oscillator 6W.

The mixer 42G mixes an output signal of the band-pass filter 25G with a high frequency signal outputted from the voltage controlled oscillator 5G, and thereby converts the high-frequency reception signal to a baseband signal. The mixer 42W mixes an output signal of the band-pass filter 37W with a high frequency signal outputted from the voltage controlled oscillator 6W, and thereby converts the high-frequency reception signal to a baseband signal.

The mixer 41G mixes a baseband signal inputted to the integrated circuit 3A with a high frequency signal outputted from the voltage controlled oscillator 4G, and thereby converts the baseband signal to a high-frequency transmission signal. The mixer 41W mixes a baseband signal inputted to the integrated circuit 3A with a high frequency signal outputted from the voltage controlled oscillator 6W, and thereby converts the baseband signal to a high-frequency transmission signal.

Although not shown, the integrated circuit 3A further comprises: a function of quadrature-modulating the received I signal and Q signal and sending the modulated signal to the mixers 41G and 41W; and a function of generating an I signal and a Q signal by quadrature-demodulating the output signals of the amplifiers 43G and 43W, and outputting the I signal and Q signal. It is possible that the mixers 41G and 41W also have a function of quadrature modulation or the mixers 42G and 42W also have a function of quadrature demodulation.

A GSM reception signal outputted from the high frequency switch 12G passes through the band-pass filter 25G and is inputted to the mixer 42G. A W-CDMA signal outputted from the duplexer 13W passes through the low-noise amplifier 36W and the band-pass filter 37W and is inputted to the mixer 42W. An output signal of the mixer 41G passes through the power amplifier 21G, the coupler 22G and the low-pass filter 24G and is inputted to the high frequency switch 12G. An output signal of the mixer 41W passes through the band-pass filter 31W, the power amplifier 32W, the coupler 33W and the isolator 35W and is inputted to the duplexer 13W.

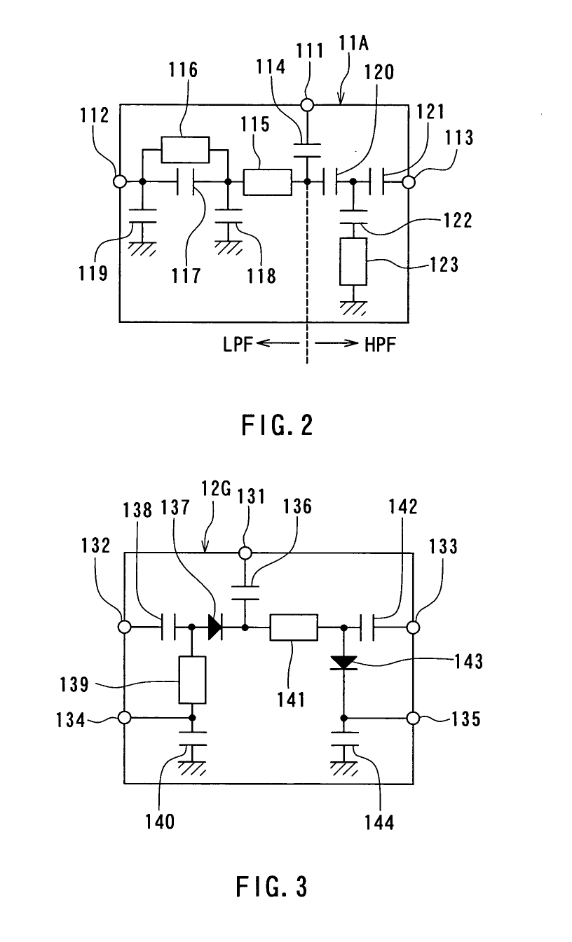

Reference is now made to FIG. 2 to describe an example of the circuit configuration of the diplexer 11A. The diplexer 11A of FIG. 2 has first to third ports 111, 112 and 113. The first port 111 is connected to the antenna 1. The second port 112 is designed to receive and output GSM signals. The third port 113 is designed to receive and output W-CDMA signals. The diplexer 11A further has: a capacitor 114 having an end connected to the first port 111; an inductor 115 having an end connected to the other end of the capacitor 114; an inductor 116 having an end connected to the other end of the inductor 115 and the other end connected to the second port 112; a capacitor 117 having an end connected to the other end of the inductor 115 and the other end connected to the second port 112; a capacitor 118 having an end connected to the other end of the inductor 115 and the other end grounded; and a capacitor 119 having an end connected to the second port 112 and the other end grounded. The inductors 115 and 116 and the capacitors 117, 118 and 119 constitute a low-pass filter (LPF) for allowing GSM transmission signals and reception signals to pass therethrough.

The diplexer 11A further has: a capacitor 120 having an end connected to the other end of the capacitor 114; a capacitor 121 having an end connected to the other end of the capacitor 120 and the other end connected to the third port 113; a capacitor 122 having an end connected to the other end of the capacitor 120; and an inductor 123 having an end connected to the other end of the capacitor 122 and the other end grounded. The capacitors 120, 121 and 122 and the inductor 123 constitute a high-pass filter (HPF) for allowing W-CDMA transmission signals and reception signals to pass therethrough.

Reference is now made to FIG. 3 to describe an example of the circuit configuration of the high frequency switch 12G. The high frequency switch 12G of FIG. 3 has the movable contact 131, the two fixed contacts 132 and 133, and two control terminals 134 and 135. The fixed contact 132 is the one indicated with T in FIG. 1. The fixed contact 133 is the one indicated with R in FIG. 1. The high frequency switch 12G further has: a capacitor 136 having an end connected to the movable contact 131; a diode 137 having a cathode connected to the other end of the capacitor 136; a capacitor 138 having an end connected to an anode of the diode 137 and the other end connected to the fixed contact 132; an inductor 139 having an end connected to the anode of the diode 137 and the other end connected to the control terminal 134; and a capacitor 140 having an end connected to the control terminal 134 and the other end grounded.

The high frequency switch 12G further has: an inductor 141 having an end connected to the other end of the capacitor 136; a capacitor 142 having an end connected to the other end of the inductor 141 and the other end connected to the fixed contact 133; a diode 143 having an anode connected to the other end of the inductor 141 and a cathode connected to the control terminal 135; and a capacitor 144 having an end connected to the control terminal 135 and the other end grounded.

In the high frequency switch 12G, when the control signal applied to the control terminal 134 is high and the control signal applied to the control terminal 135 is low, the two diodes 137 and 143 both turn on and the fixed contact 132 is connected to the movable contact 131. When the control signal applied to the control terminal 134 is low and the control signal applied to the control terminal 135 is high, the two diodes 137 and 143 both turn off and the fixed contact 133 is connected to the movable contact 131.

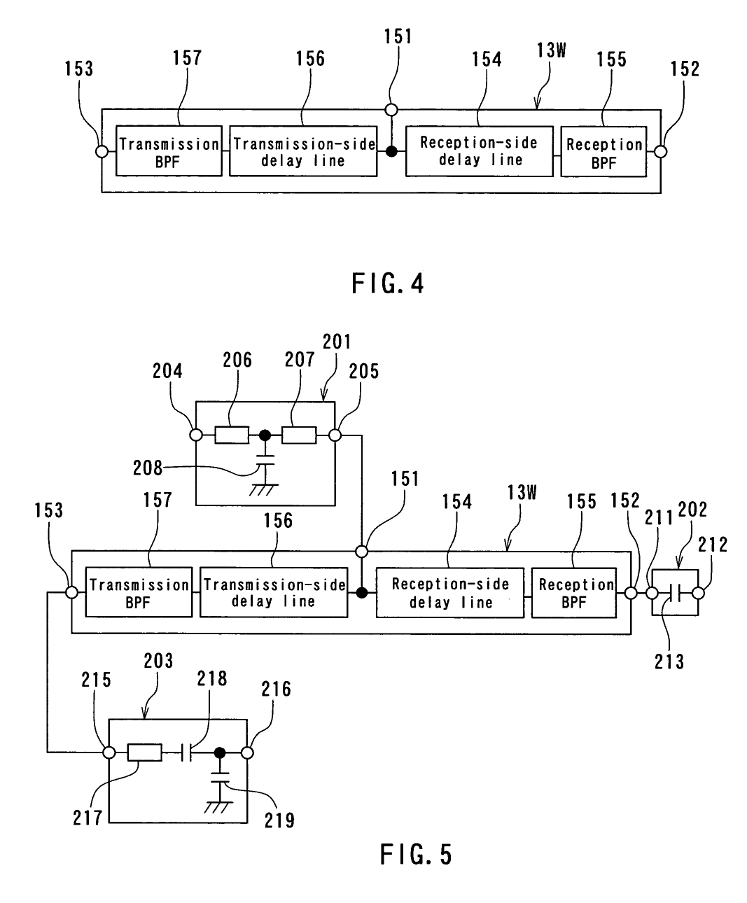

Reference is now made to FIG. 4 to describe an example of the circuit configuration of the duplexer 13W. The duplexer 13W of FIG. 4 has a common terminal 151, a reception terminal 152 and a transmission terminal 153. The duplexer 13W further has: a reception-side delay line 154 having an end connected to the common terminal 151; and a reception-side band-pass filter (indicated as reception BPF in FIG. 4) 155 having an input connected to the other end of the delay line 154 and an output connected to the reception terminal 152. The duplexer 13W further has: a transmission-side delay line 156 having an end connected to the common terminal 151; and a transmission-side band-pass filter (indicated as transmission BPF in FIG. 4) 157 having an output connected to the other end of the delay line 156 and an input connected to the transmission terminal 153. Each of the band-pass filters 155 and 157 is made up of an acoustic wave element.

The reception-side delay line 154 is inserted between the common terminal 151 and the reception-side band-pass filter 155, so that the impedance is nearly 50 ohms in the frequency band of the reception signal and the impedance is sufficiently high in the frequency band of the transmission signal when the duplexer 13W is seen from the reception terminal 152. Similarly, the transmission-side delay line 156 is inserted between the common terminal 151 and the transmission-side band-pass filter 157, so that the impedance is nearly 50 ohms in the frequency band of the transmission signal and the impedance is sufficiently high in the frequency band of the reception signal when the duplexer 13W is seen from the transmission terminal 153. Depending on the configurations of the band-pass filters 155 and 157, one of the reception-side delay line 154 and the transmission-side delay line 156 may be only provided in some cases.

Alternatively, a matching circuit for performing impedance matching between the duplexer 13W and an external circuit may be provided between each of the common terminal 151, the reception terminal 152 and the transmission terminal 153 of the duplexer 13W of FIG. 4 and the external circuit connected thereto. FIG. 5 is a schematic diagram illustrating an example of the circuit configuration of the duplexer 13W and the matching circuits connected thereto. The duplexer 13W of the example shown in FIG. 5 has a configuration the same as that of the duplexer 13W of FIG. 4. In the example shown in FIG. 5 the matching circuit 201 is connected to the common terminal 151, the matching circuit 202 is connected to the reception terminal 152, and the matching circuit 203 is connected to the transmission terminal 153. The matching circuits 201, 202 and 203 are included in the front end module 2A.

The matching circuit 201 has: two terminals 204 and 205; an inductor 206 having an end connected to the terminal 204; an inductor 207 having an end connected to the other end of the inductor 206 and the other end connected to the terminal 205; and a capacitor 208 having an end connected to the other end of the inductor 206 and the other end grounded. The terminal 204 is connected to the third port of the diplexer 11A of FIG. 1. The terminal 205 is connected to the common terminal 151 of the duplexer 13W.

The matching circuit 202 has two terminals 211 and 212 and a capacitor 213 connected between the terminals 211 and 212. The terminal 211 is connected to the reception terminal 152 of the duplexer 13W. The terminal 212 is connected to the input of the low-noise amplifier 36W of FIG. 1.

The matching circuit 203 has: two terminals 215 and 216; an inductor 217 having an end connected to the terminal 215; a capacitor 218 having an end connected to the other end of the inductor 217 and the other end connected to the terminal 216; and a capacitor 219 having an end connected to the other end of the capacitor 218 and the other end grounded. The terminal 215 is connected to the transmission terminal 153 of the duplexer 13W. The terminal 216 is connected to the output of the isolator 35W of FIG. 1.

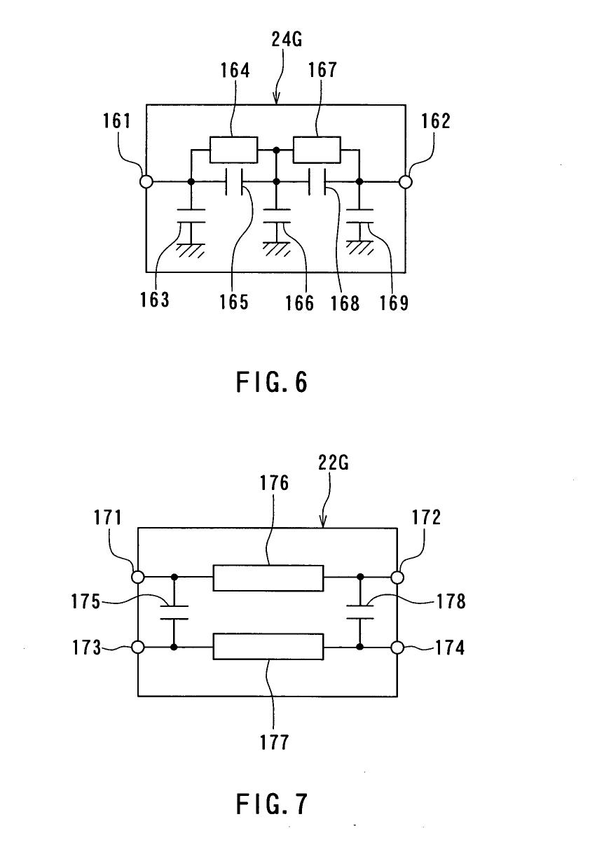

Reference is now made to FIG. 6 to describe an example of the circuit configuration of the low-pass filter 24G. The low-pass filter 24G of FIG. 6 has an input terminal 161 and an output terminal 162. The low-pass filter 24G further has: a capacitor 163 having an end connected to the input terminal 161 and the other end grounded; an inductor 164 having an end connected to the input terminal 161; a capacitor 165 having an end connected to the input terminal 161 and the other end connected to the other end of the inductor 164; and a capacitor 166 having an end connected to the other end of the inductor 164 and the other end grounded. The low-pass filter 24G further has: an inductor 167 having an end connected to the other end of the inductor 164 and the other end connected the output terminal 162; a capacitor 168 having an end connected to the other end of the inductor 164 and the other end connected the output terminal 162; and a capacitor 169 having an end connected the output terminal 162 and the other end grounded.

Reference is now made to FIG. 7 to describe an example of the circuit configuration of the coupler 22G. The coupler 22G of FIG. 7 has an input terminal 171, an output terminal 172, a monitor terminal 173 and a load connecting terminal 174. The coupler 22G further has: a capacitor 175 having an end connected to the input terminal 171 and the other end connected to the monitor terminal 173; an inductor 176 having an end connected to the input terminal 171 and the other end connected to the output terminal 172; an inductor 177 having an end connected to the monitor terminal 173 and the other end connected to the load connecting terminal 174; and a capacitor 178 having an end connected to the output terminal 172 and the other end connected to the load connecting terminal 174. The monitor terminal 173 is connected to the input of the automatic power control circuit 23G. The load connecting terminal 174 is grounded through a load of 50 ohms. The coupler 33W has a circuit configuration the same as that of the coupler 22G.

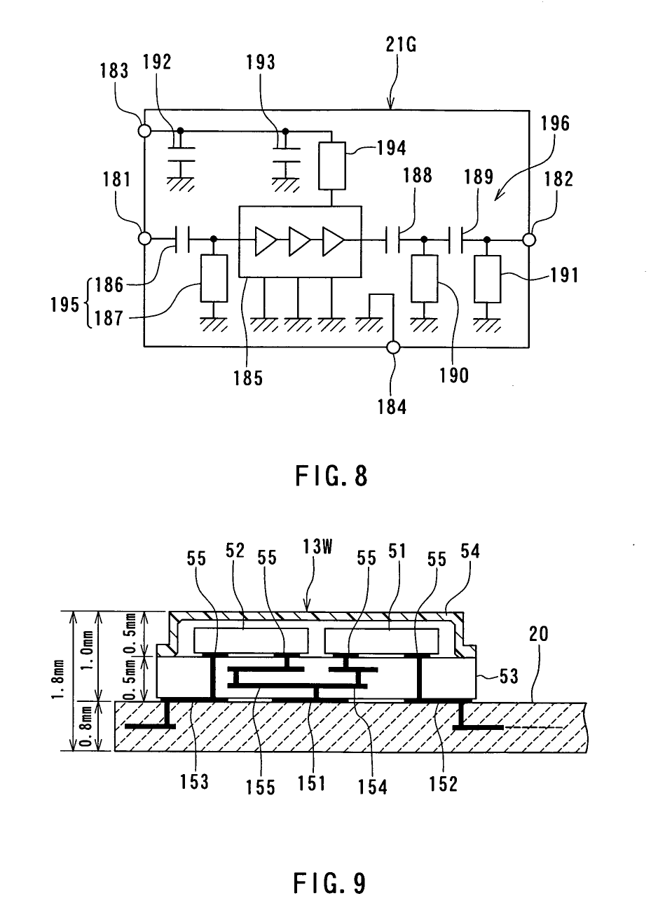

Reference is now made to FIG. 8 to describe an example of the circuit configuration of the power amplifier 21G. The power amplifier 21G of FIG. 8 has an input terminal 181, an output terminal 182, a power terminal 183 and a ground terminal 184. A supply voltage is applied to the power terminal 183.

The power amplifier 21G further has a monolithic microwave integrated circuit (hereinafter referred to as MMIC) 185 that functions as an amplifier. The MMIC 185 has a ground end connected to the ground terminal 184. The power amplifier 21G further has: a capacitor 186 having an end connected to the input terminal 181 and the other end connected to an input of the MMIC 185; and an inductor 187 having an end connected to the other end of the capacitor 186 and the other end connected to the ground terminal 184. The capacitor 186 and the inductor 187 constitute an input matching circuit 195.

The power amplifier 21G further has: a capacitor 188 having an end connected to an output of the MMIC 185; a capacitor 189 having an end connected to the other end of the capacitor 188 and the other end connected to the output terminal 182; an inductor 190 having an end connected to the other end of the capacitor 188 and the other end connected to the ground terminal 184; and an inductor 191 having an end connected to the output terminal 182 and the other end connected to the ground terminal 184. The capacitors 188 and 189 and the inductors 190 and 191 constitute an output matching circuit 196.

The power amplifier 21G further has: capacitors 192 and 193 each having an end connected to the power terminal 183 and the other end connected to the ground terminal 184; and a choke coil 194 having an end connected to the power terminal 183 and the other end connected to the power input of the MMIC 185. The power amplifier 32W has a circuit configuration the same as that of the power amplifier 21G.

The structure of the front end module 2A will now be described. The front end module 2A comprises a single multi-layer substrate for integration of the diplexer 11A, the high frequency switch 12G and the duplexer 13W. The multi-layer substrate has a structure in which dielectric layers and patterned conductor layers are alternately stacked. The circuit of the front end module 2A is made up of the conductor layers located inside or on the surface of the multi-layer substrate, and elements mounted on the substrate.

Reference is now made to FIG. 9 to FIG. 11 to describe three examples of the structure of the duplexer 13W of the present embodiment one by one. Although surface acoustic wave elements are employed as acoustic wave elements in the examples herein described, it is possible to use bulk acoustic wave elements in place of the surface acoustic wave elements. While the surface acoustic wave elements utilize acoustic waves (surface acoustic waves) that propagate across the surface of a piezoelectric material, the bulk acoustic wave elements utilize acoustic waves (bulk acoustic waves) that propagate inside a piezoelectric material. Some of the bulk acoustic wave elements made of piezoelectric thin films in particular are called thin-film bulk acoustic wave elements. Resonators made of piezoelectric thin films in particular are called film bulk acoustic resonators (FBAR). The above-mentioned thin-film bulk acoustic wave elements may be used as the above-mentioned acoustic wave elements. The thin-film bulk acoustic wave elements have a temperature characteristic better than the surface acoustic wave elements. Typically, the thin-film bulk acoustic wave elements have a temperature characteristic of around 20 ppm/° C. while the surface acoustic wave elements have a temperature characteristic of around 40 ppm/° C. Therefore, the thin-film bulk acoustic wave elements are suitable for achieving a steep frequency characteristic required for the filters.

FIG. 9 is a cross-sectional view for illustrating the first example of the structure of the duplexer 13W. In the first example the duplexer 13W has: a chip 51 including a surface acoustic wave element used in the reception-side band-pass filter 155 of FIG. 4; a chip 52 including a surface acoustic wave element used in the transmission-side band-pass filter 157 of FIG. 4; a mounting board 53 on which the two chips 51 and 52 are mounted; and a cap 54 for sealing the chips 51 and 52. The mounting board 53 may be a multi-layer ceramic substrate in which the dielectric layers are made of ceramic, for example. The mounting board 53 includes the components that make up the duplexer 13W except the surface acoustic wave elements. For example, the reception-side delay line 154 and the transmission-side delay line 156 of the duplexer 13W are made of the conductor layers located inside or on the surface of the mounting board 53. The common terminal 151, the reception terminal 152 and the transmission terminal 153 of the duplexer 13W are disposed at the bottom surface of the mounting board 53.

Each of the chips 51 and 52 has: a piezoelectric substrate made of a piezoelectric material such as LiTaO₃; an inter-digital electrode formed on one of the surfaces of the piezoelectric substrate; and a connecting electrode 55 for connecting the inter-digital electrode to an external circuit. In the example shown in FIG. 9 the connecting electrode 55 is disposed in the same plane as the inter-digital electrode. In the example the chips 51 and 52 are mounted on the mounting board 53 by flip-chip bonding so that the inter-digital electrode faces toward the top surface of the mounting board 53. When the chips 51 and 52 are mounted on the mounting board 53, a space is created between the inter-digital electrode and the top surface of the mounting board 53.

In the first example the duplexer 13W having the above-described configuration is mounted on the multi-layer substrate 20 of the front end module 2A. The multi-layer substrate 20 may be a multi-layer low-temperature co-fired ceramic substrate, for example. The multi-layer substrate 20 includes the circuits of the front end module 2A except the duplexer 13W.

FIG. 9 shows an example of the thickness of the front end module 2A of the first example. In this example the mounting board 53 of the duplexer 13W has a thickness of 0.5 millimeter (mm), a portion of the duplexer 13W from the top surface of the mounting board 53 to the top surface of the cap 54 has a thickness of 0.5 mm, and the multi-layer substrate 20 has a thickness of 0.8 mm. Therefore, the front end module 2A of this example has a thickness of 1.8 mm or greater.

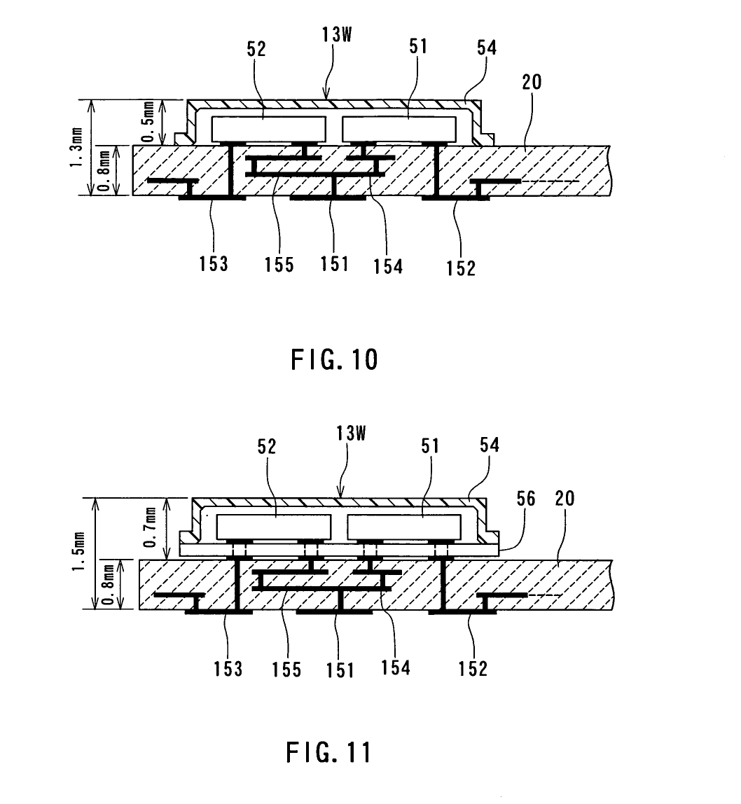

FIG. 10 is a cross-sectional view for illustrating the second example of the structure of the duplexer 13W. In the second example the duplexer 13W has the chips 51 and 52 the same as those of the first example. However, the mounting board 53 is not provided in the second example but the chips 51 and 52 are mounted directly on the multi-layer substrate 20 of the front end module 2A. The chips 51 and 52 may be mounted on the multi-layer substrate 20 by flip-chip bonding so that the inter-digital electrode faces toward the top surface of the multi-layer substrate 20. When the chips 51 and 52 are mounted on the multi-layer substrate 20, a space is created between the inter-digital electrode and the top surface of the multi-layer substrate 20. The chips 51 and 52 are sealed by the cap 54.

In the second example the multi-layer substrate 20 includes the components of the duplexer 13W except the surface acoustic wave elements. For example, the reception-side delay line 154 and the transmission-side delay line 156 of the duplexer 13W are made of the conductor layers located inside or on the surface of the multi-layer substrate 20. The common terminal 151, the reception terminal 152 and the transmission terminal 153 of the duplexer 13W are disposed at the bottom surface of the multi-layer substrate 20. The multi-layer substrate 20 includes the circuits of the front end module 2A except the duplexer 13W. The front end module 2A of the second example including the duplexer 13W corresponds to the first high frequency functional module of the invention. It is acceptable that the first high frequency functional module includes at least the duplexer 13W and the multi-layer substrate 20 and may be part of the front end module 2A. It is acceptable that the multi-layer substrate 20 of the first high frequency functional module includes at least part of a circuit connected to the duplexer 13W and/or at least part of the components of the duplexer 13W except the surface acoustic wave elements. That is, the multi-layer substrate 20 of the first high frequency functional module may include only part of the components of the duplexer 13W except the surface acoustic wave elements, or only part of the circuit connected to the duplexer 13W.

FIG. 10 shows an example of the thickness of the front end module 2A of the second example. In this example a portion of the duplexer 13W from the top surface of the multi-layer substrate 20 to the top surface of the cap 54 has a thickness of 0.5 mm, and the multi-layer substrate 20 has a thickness of 0.8 mm. Therefore, the front end module 2A of this example has a thickness of 1.3 mm or greater.

FIG. 11 is a cross-sectional view for illustrating the third example of the structure of the duplexer 13W. In the third example the duplexer 13W has: the chips 51 and 52 the same as those of the first example; a mounting board 56 or two mounting boards 56 on which the chips 51 and 52 are mounted; and the cap 54 for sealing the chips 51 and 52. Although the two chips 51 and 52 are mounted on the single mounting board 56 in the example shown in FIG. 11, it is possible that the chips 51 and 52 are mounted on the respective mounting boards 56.

The mounting board 56 has a single-layer dielectric layer, patterned conductor layers provided on the top and bottom surfaces of the dielectric layer, and a conductor portion provided on the side surfaces of the dielectric layer and connecting the conductor layer provided on the top surface of the dielectric layer to the conductor layer provided on the bottom surface of the dielectric layer. The chips 51 and 52 may be mounted on the mounting board 56 by flip-chip bonding so that the inter-digital electrode faces toward the top surface of the mounting board 56, for example. When the chips 51 and 52 are mounted on the mounting board 56, a space is created between the inter-digital electrode and the top surface of the mounting board 56.

The chips 51 and 52 and the mounting board 56 are mounted on the multi-layer substrate 20 of the front end module 2A. In the third example the multi-layer substrate 20 includes the components of the duplexer 13W except the surface acoustic wave elements. For example, the reception-side delay line 154 and the transmission-side delay line 156 of the duplexer 13W are made of the conductor layers located inside or on the surface of the multi-layer substrate 20. The common terminal 151, the reception terminal 152 and the transmission terminal 153 of the duplexer 13W are disposed on the bottom surface of the multi-layer substrate 20. The multi-layer substrate 20 includes the circuits of the front end module 2A except the duplexer 13W. The front end module 2A of the third example including the duplexer 13W corresponds to the second high frequency functional module of the invention. It is acceptable that the second high frequency functional module includes at least the duplexer 13W and the multi-layer substrate 20 and may be part of the front end module 2A. It is acceptable that the multi-layer substrate 20 of the second high frequency functional module includes at least part of a circuit connected to the duplexer 13W and/or at least part of the components of the duplexer 13W except the surface acoustic wave elements. That is, the multi-layer substrate 20 of the second high frequency functional module may include only part of the components of the duplexer 13W except the surface acoustic wave elements, or only part of the circuit connected to the duplexer 13W.

FIG. 11 shows an example of the thickness of the front end module 2A of the third example. In this example a portion of the duplexer 13W from the top surface of the multi-layer substrate 20 to the top surface of the cap 54 has a thickness of 0.7 mm, and the multi-layer substrate 20 has a thickness of 0.8 mm. Therefore, the front end module 2A of this example has a thickness of 1.5 mm or greater.

According to the front end module 2A of the embodiment as thus described, the diplexer 11A, the high frequency switch 12G and the duplexer 13W including the two acoustic wave elements are integrated on the single multi-layer substrate 20. The duplexer 13W including the acoustic wave elements is smaller in size and weight and easier to combine and integrate with the front end module 2A, compared to the coaxial dielectric type duplexer. As a result, according to the embodiment, it is possible to implement the front end module 2A that is operable in the time division multiple access system (GSM) and the code division multiple access system (W-CDMA) and easily achieves a reduction in size and weight, and higher combination and integration of components.

According to the embodiment, the duplexer 13W including the acoustic wave elements is integrated with the diplexer 11A and the high frequency switch 12G, so that the impedance matching between the duplexer 13W and the periphery circuits is optimized. As a result, an improvement in performance of the front end module 2A is achieved, too.

For the duplexer 13W the impedance of each of the common terminal 151, the reception terminal 152 and the transmission terminal 153 is set to 50 ohms for the frequencies in the pass band so that the insertion loss is minimized, and set to such a value for the frequencies in the rejection band that the attenuation is increased. Therefore, it is required to optimize the characteristic of the duplexer 13W as a whole including the acoustic wave elements and the components (the delay lines 154 and 156 and the matching circuits) besides the acoustic wave elements.

In the first example of the structure of the duplexer 13W shown in FIG. 9, the chips 51 and 52 each including the acoustic wave element and the mounting board 53 including the components of the duplexer 13W except the acoustic wave elements are integrated. As a result, according to the first example, it is possible to manufacture the duplexer 13W independently from the other components of the front end module 2A. It is thereby possible to mount the duplexer 13W having an optimized characteristic on the multi-layer substrate 20. However, the first example has a problem that the thickness of the front end module 2A is increased.

In the second example of the structure of the duplexer 13W shown in FIG. 10, the components of the duplexer 13W except the acoustic wave elements are provided in the multi-layer substrate 20, and the chips 51 and 52 each including the acoustic wave element are mounted on the multi-layer substrate 20. According to the second example, it is possible to reduce the thickness of the front end module 2A. In addition, according to the second example, it is possible that the characteristics of the chips 51 and 52 and the characteristics of the components of the duplexer 13W except the acoustic wave elements provided in the multi-layer substrate 20 are designed so as to optimize the characteristic of the duplexer 13W as a whole. Through the use of the chips 51 and 52 and the multi-layer substrate 20 having the characteristics as designed, the characteristic of the duplexer 13W as a whole is optimized.

It is required to use a probe to measure the characteristics of the chips 51 and 52 as bare chips. However, it is difficult to measure the high frequency characteristics of the chips 51 and 52 with accuracy since the probe itself has a high frequency characteristic. As a result, there arises a problem that some percent of the chips 51 and 52 mounted on the multi-layer substrates 20 are nonconforming ones. If the nonconforming chips 51 and 52 are mounted on the multi-layer substrate 20, the entire front end module 2A is nonconforming even though the components of the front end module 2A except the duplexer 13W have good characteristics. Therefore, the second example has a problem that the yield of the front end module 2A is reduced.

In the third example of the structure of the duplexer 13W shown in FIG. 11, the chips 51 and 52 each including the acoustic wave element are mounted on the mounting board 56. Therefore, the chips 51 and 52 and the mounting board 56 make up a single packaged component. According to the third example, the components of the duplexer 13W except the acoustic wave elements are provided in the multi-layer substrate 20, and the chips 51 and 52 and the mounting board 56 are mounted on the multi-layer substrate 20. It is possible to measure the characteristic of the component made up of the chips 51 and 52 and the mounting board 56 with accuracy by using a jig for measuring ordinary components without using a probe. Consequently, according to the third example, it is possible to mount only conforming ones of the chips 51 and 52 and the mounting boards 56 on the multi-layer substrate 20. As a result, the yield of the front end module 2A is improved. According to the third example, it is possible to reduce the thickness of the front end module 2A, too, since it is acceptable that the mounting board 56 is thin.

Three modification examples of the front end module 2A of the embodiment will now be described.

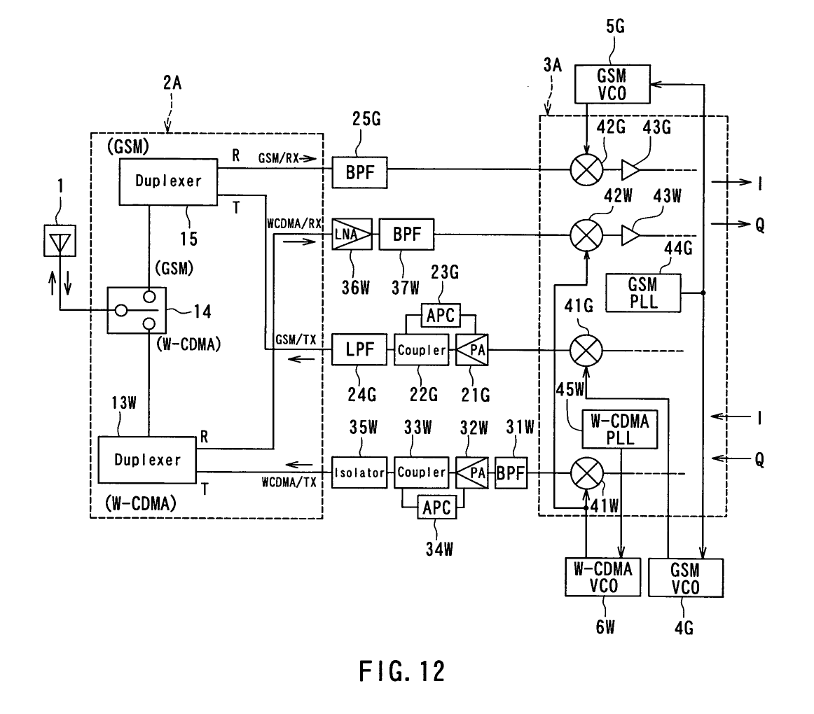

FIG. 12 is a block diagram illustrating a high frequency circuit of a cellular phone including the front end module 2A of the first modification example. The front end module 2A of the first modification example comprises a high frequency switch 14 in place of the diplexer 11A of FIG. 1, and comprises a duplexer 15 in place of the high frequency switch 12G of FIG. 1. The high frequency switch 14 has a movable contact connected to the antenna 1. The high frequency switch 14 has two fixed contacts one of which (the one indicated with GSM) is connected to a common terminal of the duplexer 15. The other one (the one indicated with W-CDMA) of the fixed contacts of the high frequency switch 14 is connected to the common terminal of the duplexer 13W.

A reception terminal (indicated with R) of the duplexer 15 is connected to the input of the band-pass filter 25G. A transmission terminal (indicated with T) of the duplexer 15 is connected to the output of the low-pass filter 24G.

The high frequency switch 14 has a circuit configuration the same as that of the high frequency switch 12G. The high frequency switch 14 corresponds to the first separating means of the invention. The duplexer 15 has a circuit configuration the same as that of the duplexer 13W. The duplexer 15 corresponds to the second separating means of the invention. The remainder of the configuration of the front end module 2A of the first modification example is the same as that of the front end module 2A of FIG. 1.

As thus described, the first separating means may be the diplexer 11A or the high frequency switch 14. The second separating means may be the high frequency switch 12G or the duplexer 15. Therefore, the diplexer 11A may be used as the first separating means and the duplexer 15 may be used as the second separating means. Alternatively, the high frequency switch 14 may be used as the first separating means and the high frequency switch 12G may be used as the second separating means.

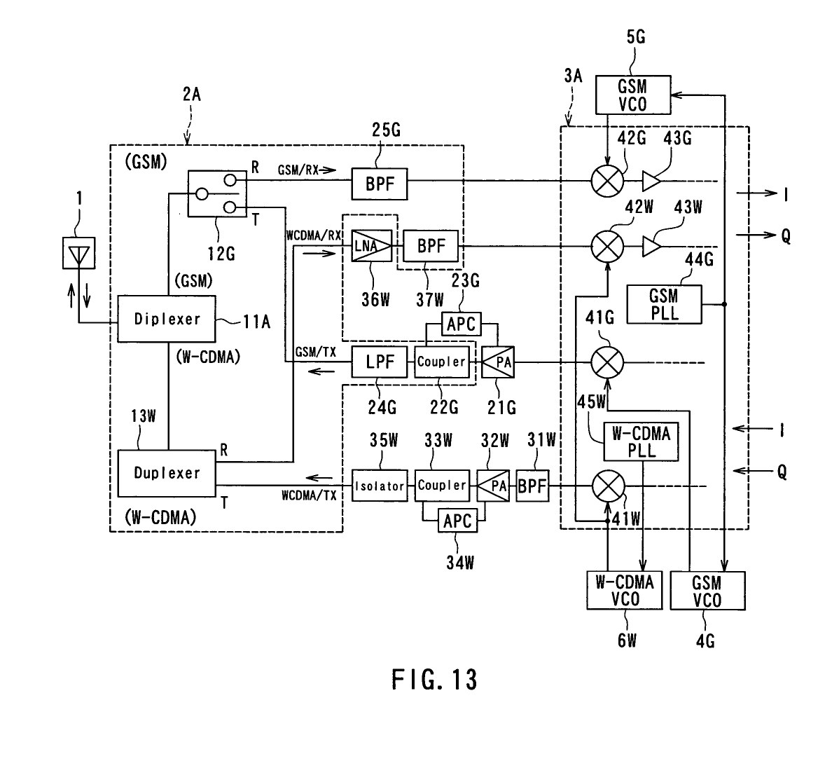

FIG. 13 is a block diagram illustrating a high frequency circuit of a cellular phone including the front end module 2A of the second modification example. In addition to the components of the front end module 2A of FIG. 1, the front end module 2A of the second modification example comprises: a coupler 22G and a low-pass filter 24G for allowing GSM transmission signals to pass therethrough; a band-pass filter 25G for allowing GSM reception signals to pass therethrough; and a band-pass filter 37W for allowing W-CDMA reception signals to pass therethrough. In the second modification example the above-mentioned additional components are integrated on the multi-layer substrate 20, in addition to the components of the front end module 2A of FIG. 1.

The remainder of the configuration of the front end module 2A of the second modification example is the same as that of the front end module 2A of FIG. 1. According to the second modification example, it is possible to optimize the characteristic of the front end module 2A as a whole including the above-mentioned additional components of the front end module 2A.

In the front end module 2A of the second modification example, the high frequency switch 14 may be used in place of the diplexer 11A, and the duplexer 15 may be used in place of the high frequency switch 12G.

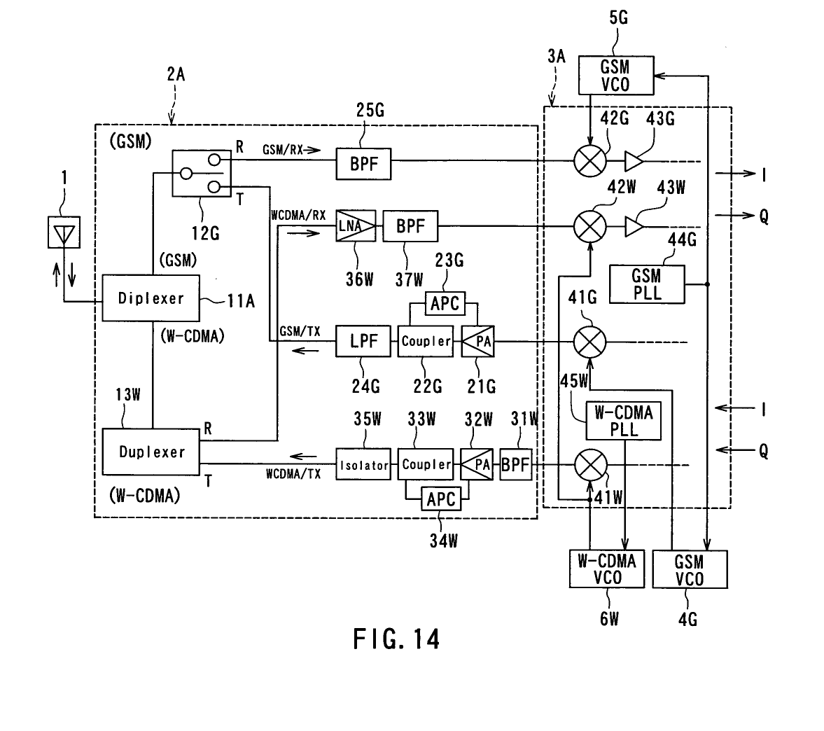

FIG. 14 is a block diagram illustrating a high frequency circuit of a cellular phone including the front end module 2A of the third modification example. In addition to the components of the front end module 2A of FIG. 1, the front end module 2A of the third modification example comprises: a power amplifier 21G, the coupler 22G, an automatic power control circuit 23G, the low-pass filter 24G, the band-pass filter 25G, a band-pass filter 31W, a power amplifier 32W, a coupler 33W, an automatic power control circuit 34W, an isolator 35W, a low-noise amplifier 36W and a band-pass filter 37W. In the third modification example the above-mentioned additional components are integrated on the multi-layer substrate 20, in addition to the components of the front end module 2A of FIG. 1.

The remainder of the configuration of the front end module 2A of the third modification example is the same as that of the front end module 2A of FIG. 1. According to the third modification example, it is possible to optimize the characteristic of the front end module 2A as a whole including the above-mentioned additional components of the front end module 2A.

In the front end module 2A of the third modification example, the high frequency switch 14 may be used in place of the diplexer 11A, and the duplexer 15 may be used in place of the high frequency switch 12G.

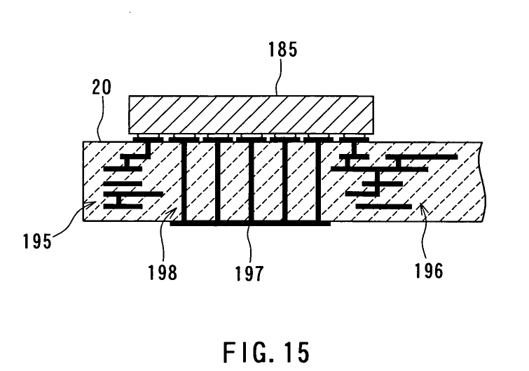

FIG. 15 is a cross-sectional view illustrating an example of arrangement of the power amplifier 21G of the front end module 2A of the third modification example. In this example the MMIC 185 of the power amplifier 21G is mounted on the multi-layer substrate 20. The power amplifier 21G has the input matching circuit 195 and the output matching circuit 196 each of which is made up of the conductor layer located inside or on the surface of the multi-layer substrate 20. Although not shown, the power amplifier 21G has the capacitors 192 and 193 and the choke coil 194 that are mounted on the multi-layer substrate 20. A conductor layer 197 for releasing the heat generated by the MMIC 185 is formed on a surface of the multi-layer substrate 20 opposite to the surface on which the MMIC 185 is mounted. The multi-layer substrate 20 further has a plurality of via holes 198 for connecting the bottom surface of the MMIC 185 to the conductor layer 197 to introduce the heat generated by the MMIC 185 to the conductor layer 197. The arrangement of the power amplifier 32W is the same as that of the power amplifier 21G.

[Second Embodiment]

A front end module of a second embodiment of the invention will now be described. The front end module of the embodiment is a module that is operable in the GSM as a time division multiple access system, the DCS as a time division multiple access system, and the W-CDMA as a code division multiple access system and that processes transmission signals and reception signals of these systems. The frequency band of transmission signals of the DCS is 1710 to 1785 MHz. The frequency band of reception signals of the DCS is 1805 to 1880 MHz. The frequency band of transmission signals and the frequency band of reception signals of the GSM and the frequency band of transmission signals and the frequency band of reception signals of the W-CDMA are the same as those of the first embodiment.

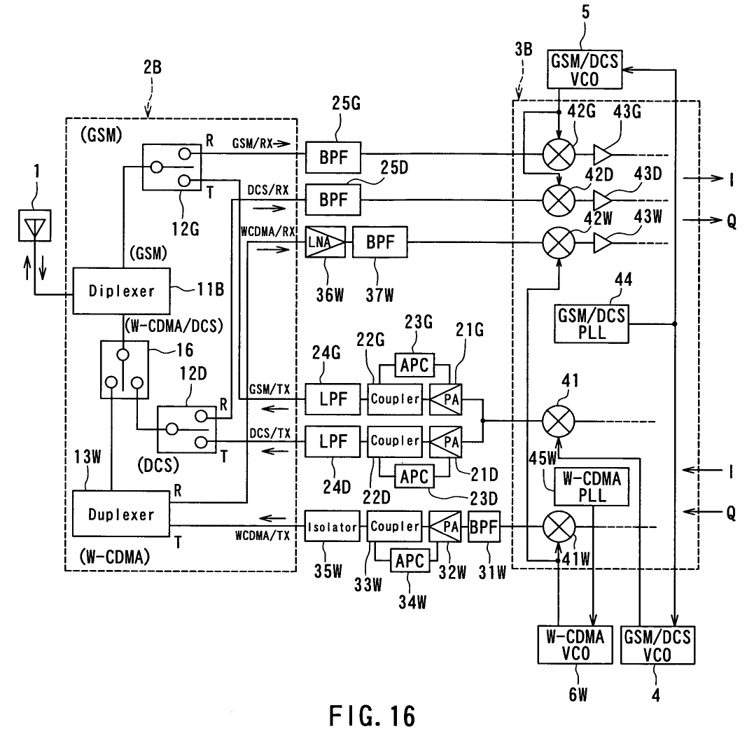

Reference is now made to FIG. 16 to describe an example of a high frequency circuit of a cellular phone including the front end module of the second embodiment. The high frequency circuit of FIG. 16 comprises the antenna 1, the front end module 2B of the embodiment connected to the antenna 1, and an integrated circuit 3B that mainly performs signal modulation and demodulation. The high frequency circuit further comprises two voltage controlled oscillators (indicated as GSM/DCS VCO in the drawing) 4 and 5 for the GSM and the DCS, and the voltage controlled oscillator 6W for the W-CDMA. The voltage controlled oscillators 4, 5 and 6W are connected to the integrated circuit 3B.

The high frequency circuit further comprises: band-pass filters 25G and 25D each having an input connected to the front end module 2B and an output connected to the integrated circuit 3B; the low-noise amplifier 36W having an input connected to the front end module 2B; and the band-pass filter 37W having an input connected to the output of the low-noise amplifier 36W and an output connected to the integrated circuit 3B. Each of the band-pass filters 25G, 25D and 37W is made up of an acoustic wave element.

The high frequency circuit further comprises the power amplifier 21G, the coupler 22G, the automatic power control circuit 23G and the low-pass filter 24G that have configurations the same as those of the first embodiment, and a power amplifier 21D, a coupler 22D, an automatic power control circuit 23D and a low-pass filter 24D for the DCS that have configurations the same as those of the power amplifier 21G, the coupler 22G, the automatic power control circuit 23G and the low-pass filter 24G.

The high frequency circuit further comprises the band-pass filter 31W, the power amplifier 32W, the coupler 33W, the automatic power control circuit 34W and the isolator 35W that have configurations the same as those of the first embodiment. The band-pass filter 31W is made up of an acoustic wave element.

The front end module 2B will now be described in detail. The front end module 2B comprises a diplexer 11B, high frequency switches 16, 12G and 12D, and the duplexer 13W. The diplexer 11B has first to third ports. The first port is connected to the antenna 1. The second port is designed to receive and output GSM signals. The third port is designed to receive and output W-CDMA signals and DCS signals.

The second port of the diplexer 11B is connected to the movable contact of the high frequency switch 12G. One (the one indicated with R) of the two fixed contacts of the high frequency switch 12G is connected to the input of the band-pass filter 25G. The other one (the one indicated with T) of the fixed contacts of the high frequency switch 12G is connected to the output of the low-pass filter 24G. The third port of the diplexer 11B is connected to a movable contact of the high frequency switch 16.

One of two fixed contacts of the high frequency switch 16 is connected to the duplexer 13W. The other one of the fixed contacts of the high frequency switch 16 is connected to a movable contact of the high frequency switch 12D. One (the one indicated with R) of two fixed contacts of the high frequency switch 12D is connected to the input of the band-pass filter 25D. The other one (the one indicated with T) of the fixed contacts of the high frequency switch 12D is connected to the output of the low-pass filter 24D.

The duplexer 13W has the common terminal, the reception terminal (the one indicated with R) and the transmission terminal (the one indicated with T). The common terminal of the duplexer 13W is connected to the one of the fixed contacts of the high frequency switch 16. The reception terminal of the duplexer 13W is connected to the input of the low-noise amplifier 36W. The transmission terminal of the duplexer 13W is connected to the output of the isolator 35W.

The diplexer 11B separates the transmission signals and reception signals of the GSM from the transmission signals and reception signals of the W-CDMA and the transmission signals and reception signals of the DCS, according to the frequencies of the signals. To be specific, the diplexer 11B outputs from the first port the GSM transmission signals inputted to the second port and the W-CDMA transmission signals or the DCS transmission signals inputted to the third port. The diplexer 11B outputs from the second port the GSM reception signals inputted to the first port, and outputs from the third port the W-CDMA reception signals or the DCS reception signals inputted to the first port. The diplexer 11B has a configuration the same as that of the diplexer 11A of the first embodiment.

The high frequency switch 16 separates the W-CDMA transmission signals and the W-CDMA reception signals from the DCS transmission signals and the DCS reception signals. To be specific, the high frequency switch 16 outputs from the movable contact the W-CDMA transmission signals inputted to one of the fixed contacts, and outputs from the one of the fixed contacts the W-CDMA reception signals inputted to the movable contact.

The high frequency switch 16 outputs from the movable contact the DCS transmission signals inputted to the other one of the fixed contacts, and outputs from the other one of the fixed contacts the DCS reception signals inputted to the movable contact. The high frequency switch 16 has a configuration the same as that of the high frequency switch 12G. The diplexer 11B and the high frequency switch 16 correspond to the first separating means of the invention.

The high frequency switch 12G separates the GSM transmission signals and the GSM reception signals from each other. The specific operation of the high frequency switch 12G is the same as that of the first embodiment and omitted here. The high frequency switch 12G corresponds to the second separating means of the invention.

The high frequency switch 12D separates the DCS transmission signals and the DCS reception signals from each other. To be specific, the high frequency switch 12D outputs from one of the fixed contacts the DCS reception signals (indicated as DCS/RX in the drawings) inputted to the movable contact, and outputs from the movable contact the DCS transmission signals (indicated as DCS/TX in the drawings) inputted to the other one of the fixed contacts. The high frequency switch 12D has a configuration the same as that of the high frequency switch 12G. The high frequency switch 12D corresponds to the third separating means of the invention.

The duplexer 13W separates the W-CDMA transmission signals and the W-CDMA reception signals from each other. The specific operation of the duplexer 13W is the same as that of the first embodiment and omitted here.

The integrated circuit 3B will now be described. The integrated circuit 3B receives an input signal of the baseband made up of an I signal and a Q signal, and outputs an output signal of the baseband made up of an I signal and a Q signal.

The integrated circuit 3B comprises: the mixer 42G having the input connected to the output of the band-pass filter 25G; the amplifier 43G having the input connected to the output of the mixer 42G; a mixer 42D having an input connected to the output of the band-pass filter 25D; an amplifier 43D having an input connected to an output of the mixer 42D; the mixer 42W having the input connected to the output of the band-pass filter 37W; the amplifier 43W having the input connected to the output of the mixer 42W; a mixer 41 having an output connected to the inputs of the power amplifiers 21G and 21D; and the mixer 41W having the output connected to the input of the band-pass filter 31W. The mixers 42G and 42D are connected to the voltage controlled oscillator 5. The mixer 42W is connected to the voltage controlled oscillator 6W. The mixer 41 is connected to the voltage controlled oscillator 4. The mixer 41W is connected to the voltage controlled oscillator 6W.

The integrated circuit 3B further comprises a phase-locked loop circuit (indicated as GSM/DCS PLL in the drawings) 44 for the GSM and the DCS and the phase-locked loop circuit 45W for the W-CDMA. The phase-locked loop circuit 44 is connected to the voltage controlled oscillators 4 and 5. The phase-locked loop circuit 45W is connected to the voltage controlled oscillator 6W.

The mixer 42G mixes an output signal of the band-pass filter 25G with a high frequency signal outputted from the voltage controlled oscillator 5, and thereby converts the high-frequency reception signal to a baseband signal. The mixer 42D mixes an output signal of the band-pass filter 25D with a high frequency signal outputted from the voltage controlled oscillator 5, and thereby converts the high-frequency reception signal to a baseband signal. The mixer 42W mixes an output signal of the band-pass filter 37W with a high frequency signal outputted from the voltage controlled oscillator 6W, and thereby converts the high-frequency reception signal to a baseband signal.

The mixer 41 mixes a baseband signal inputted to the integrated circuit 3B with a high frequency signal outputted from the voltage controlled oscillator 4, and thereby converts the baseband signal to a high-frequency transmission signal. The mixer 41W mixes a baseband signal inputted to the integrated circuit 3B with a high frequency signal outputted from the voltage controlled oscillator 6W, and thereby converts the baseband signal to a high-frequency transmission signal.

Although not shown, the integrated circuit 3B further comprises: a function of quadrature-modulating the received I signal and Q signal and sending the modulated signal to the mixers 41 and 41W; and a function of generating an I signal and a Q signal by quadrature-demodulating the output signals of the amplifiers 43G, 43D and the 43W, and outputting the I signal and Q signal. It is possible that the mixers 41 and 41W also have a function of quadrature modulation or the mixers 42G, 42D and 42W also have a function of quadrature demodulation.

A GSM reception signal outputted from the high frequency switch 12G passes through the band-pass filter 25G and is inputted to the mixer 42G. A DCS reception signal outputted from the high frequency switch 12D passes through the band-pass filter 25D and is inputted to the mixer 42D. A W-CDMA reception signal outputted from the duplexer 13W passes through the low-noise amplifier 36W and the band-pass filter 37W and is inputted to the mixer 42W.

An output signal of the mixer 41 passes through the power amplifier 21G, the coupler 22G and the low-pass filter 24G and is inputted to the high frequency switch 12G. In addition, an output signal of the mixer 41 passes through the power amplifier 21D, the coupler 22D and the low-pass filter 24D and is inputted to the high frequency switch 12D. An output signal of the mixer 41W passes through the band-pass filter 31W, the power amplifier 32W, the coupler 33W and the isolator 35W and is inputted to the duplexer 13W.

The structure of the front end module 2B will now be described. The front end module 2B comprises the single multi-layer substrate 20 for integration of the diplexer 11B, the high frequency switches 16, 12G and 12D and the duplexer 13W. The basic structure of the multi-layer substrate 20 is the same as that of the first embodiment. The structure of the duplexer 13W of the second embodiment may be any of the first to third examples shown in FIG. 9 to FIG. 11 as the first embodiment.

According to the front end module 2B of the embodiment as thus described, the diplexer 11B, the high frequency switches 16, 12G and 12D and the duplexer 13W including the two acoustic wave elements are integrated on the single multi-layer substrate 20. As a result, according to the embodiment, it is possible to implement the front end module 2B that is operable in the two types of time division multiple access systems (the GSM and the DCS) and the one type of code division multiple access system (the W-CDMA) and easily achieves a reduction in size and weight, and higher combination and integration of components.

The remainder of configuration, operation and effects of the second embodiment are similar to those of the first embodiment. In the second embodiment the high frequency switch 14 of FIG. 12 may be used in place of the diplexer 11B, the duplexer 15 of FIG. 12 may be used in place of the high frequency switch 12G, and the duplexer 15 of FIG. 12 may be used in place of the high frequency switch 12D.

Two modification examples of the front end module 2B of the second embodiment will now be described.

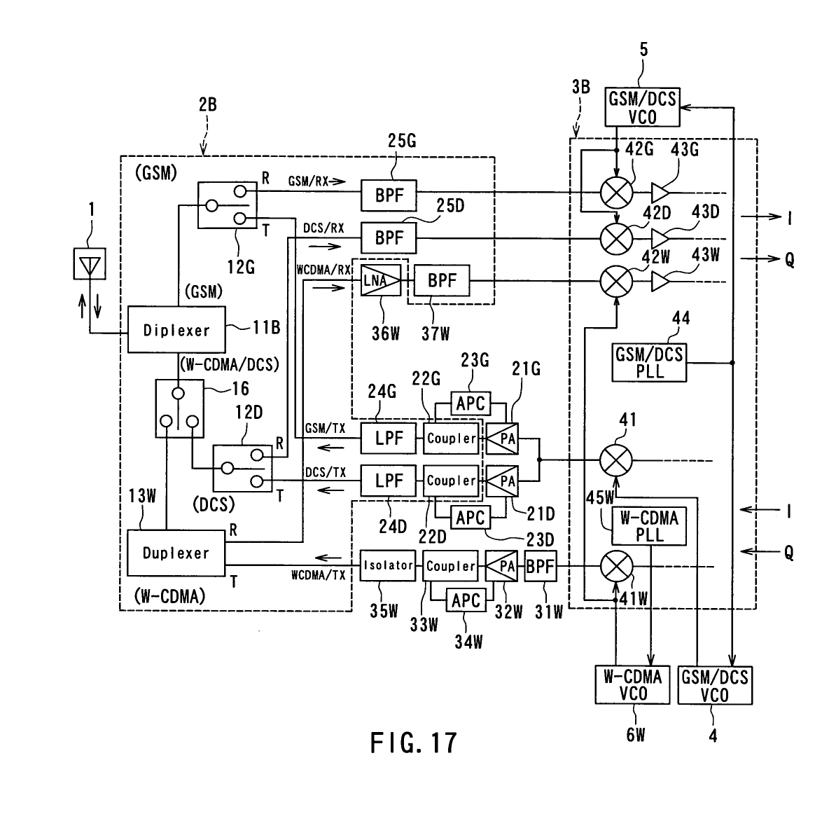

FIG. 17 is a block diagram illustrating a high frequency circuit of a cellular phone including the front end module 2B of the first modification example. In addition to the components of the front end module 2B shown in FIG. 16, the front end module 2B of the first modification example comprises: the coupler 22G and the low-pass filter 24G for allowing GSM transmission signals to pass therethrough; the coupler 22D and the low-pass filter 24D for allowing DCS transmission signals to pass therethrough; the band-pass filter 25G for allowing GSM reception signals to pass therethrough; the band-pass filter 25D for allowing DCS reception signals to pass therethrough; and the band-pass filter 37W for allowing W-CDMA reception signals to pass therethrough. In the first modification example the multi-layer substrate 20 is used to integrate the above-mentioned additional components, too, in addition to the components of the front end module 2B shown in FIG. 16.

The remainder of configuration of the front end module 2B of the first modification example is the same as that of the front end module 2B shown in FIG. 16. According to the first modification example, it is possible to optimize the characteristic of the front end module 2B as a whole including the above-mentioned additional components of the front end module 2B.

In the front end module 2B of the first modification example, the high frequency switch 14 may be used in place of the diplexer 11B, the duplexer 15 may be used in place of the high frequency switch 12G, and the duplexer 15 may be used in place of the high frequency switch 12D.

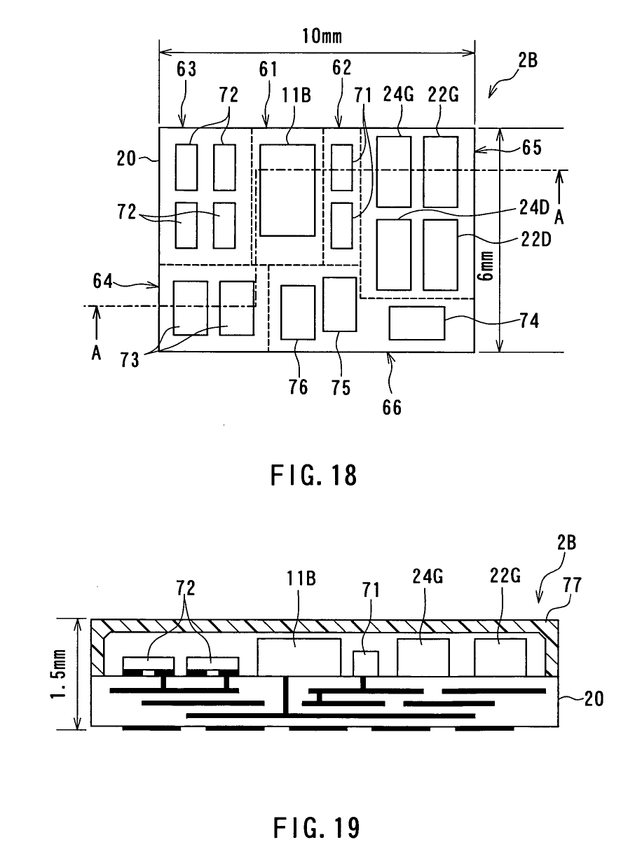

FIG. 18 is a top view illustrating an example of the structure of the front end module 2B of the first modification example. FIG. 19 is a cross-sectional view of the front end module 2B of FIG. 18 taken along line A-A. In this example, as shown in FIG. 18, six regions are formed on the top surface of the multi-layer substrate 20. The six regions are a diplexer section 61, a high frequency switch circuit section 62, a high frequency switch circuit section 63, a duplexer section 64, a transmission circuit section 65 and a reception circuit section 66.

The diplexer 11B is mounted on the diplexer section 61. Two diodes 71 that the high frequency switch 12G includes are mounted on the high frequency switch circuit section 62. Two diodes 72 that the high frequency switch 16 includes and two diodes 72 that the high frequency switch 12D includes are mounted on the high frequency switch circuit section 63. Two chips 73 that the duplexer 13W includes are mounted on the duplexer section 64. Each of the two chips 73 includes an acoustic wave element. The low-pass filters 24G and 24D and the couplers 22G and 22D are mounted on the transmission circuit section 65. A chip 74 that the band-pass filter 25G includes, a chip 75 that the band-pass filter 25D includes, and a chip 76 that the band-pass filter 37W includes are mounted on the reception circuit section 66. Each of the chips 74, 75 and 76 includes an acoustic wave element. As shown in FIG. 2, FIG. 6 and FIG. 7, it is possible that the diplexer 11B, the low-pass filters 24G and 24D and the couplers 22G and 22D are made up of inductors and capacitors, so that all or some of these components may be provided inside the multi-layer substrate 20.

As shown in FIG. 19, the above-mentioned components mounted on the top surface of the multi-layer substrate 20 is covered with a shield case 77 which is omitted in FIG. 18.

In this example, as shown in FIG. 18, the multi-layer substrate 20 has the top surface having the shape of a rectangle of 6 mm in length and 10 mm in width. As shown in FIG. 19, the front end module 2B has a thickness of 1.5 mm.

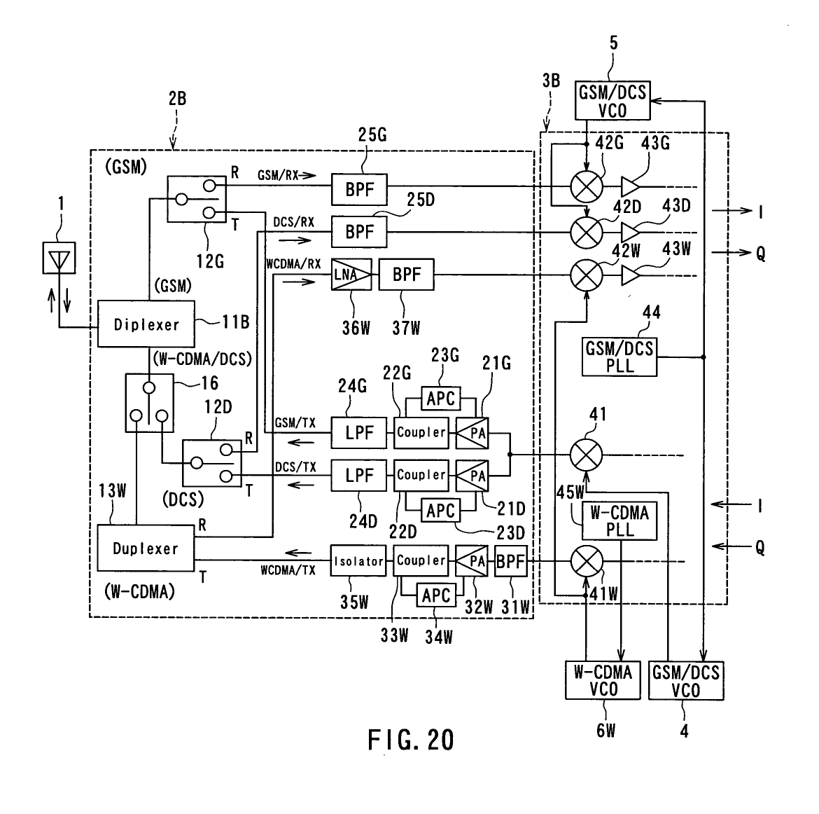

FIG. 20 is a block diagram illustrating a high frequency circuit of a cellular phone including the front end module 2B of the second modification example. In addition to the components of the front end module 2B shown in FIG. 16, the front end module 2B of the second modification example comprises the power amplifiers 21G and 21D, the couplers 22G and 22D, the automatic power control circuits 23G and 23D, the low-pass filters 24G and 24D, the band-pass filters 25G and 25D, the band-pass filter 31W, the power amplifier 32W, the coupler 33W, the automatic power control circuit 34W, the isolator 35W, the low-noise amplifier 36W, and the band-pass filter 37W. In the second modification example the multi-layer substrate 20 is used to integrate the above-mentioned additional components, too, in addition to the components of the front end module 2B shown in FIG. 16.

The remainder of configuration of the front end module 2B of the second modification example is the same as that of the front end module 2B shown in FIG. 16. According to the second modification example, it is possible to optimize the characteristic of the front end module 2B as a whole including the above-mentioned additional components of the front end module 2B.

In the front end module 2B of the second modification example, the high frequency switch 14 may be used in place of the diplexer 11B, the duplexer 15 may be used in place of the high frequency switch 12G, and the duplexer 15 may be used in place of the high frequency switch 12D.

[Third Embodiment]

A front end module of a third embodiment of the invention will now be described. The front end module of the third embodiment is a module that is operable in the GSM as a time division multiple access system, the DCS as a time division multiple access system, the W-CDMA as a code division multiple access system, and the narrow-band code division multiple access system (hereinafter called the N-CDMA) as a code division multiple access system, and that performs processing of transmission signals and reception signals of these systems. The frequency band of transmission signals of the N-CDMA is 824 to 849 MHz. The frequency band of reception signals of the N-CDMA is 869 to 894 MHz. The frequency band of transmission signals and the frequency band of reception signals of the GSM and the frequency band of transmission signals and the frequency band of reception signals of the W-CDMA are the same as those of the first embodiment. The frequency band of transmission signals and the frequency band of reception signals of the DCS are the same as those of the second embodiment.

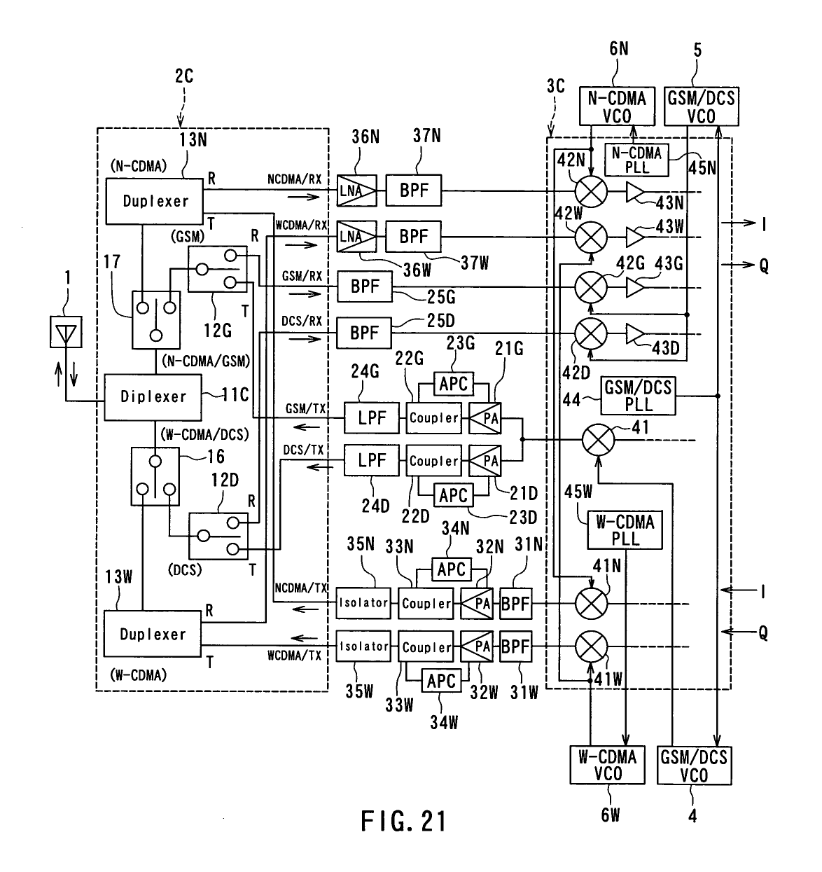

Reference is now made to FIG. 21 to describe an example of a high frequency circuit of a cellular phone including the front end module of the third embodiment. The high frequency circuit of FIG. 21 comprises the antenna 1, the front end module 2C of the embodiment connected to the antenna 1, and an integrated circuit 3C that mainly performs signal modulation and demodulation. The high frequency circuit further comprises the two voltage controlled oscillators 4 and 5 for the GSM and the DCS, the voltage controlled oscillator 6W for the W-CDMA, and a voltage controlled oscillator 6N for the N-CDMA. The voltage controlled oscillators 4, 5, 6W and 6N are connected to the integrated circuit 3C.

The high frequency circuit further comprises: the band-pass filters 25G and 25D each having an input connected to the front end module 2C and an output connected to the integrated circuit 3C; the low-noise amplifier 36W having an input connected to the front end module 2C; the band-pass filter 37W having an input connected to the output of the low-noise amplifier 36W and an output connected to the integrated circuit 3C; a low-noise amplifier 36N having an input connected to the front end module 2C; and a band-pass filter 37N having an input connected to an output of the low-noise amplifier 36N and an output connected to the integrated circuit 3C. Each of the band-pass filters 25G, 25D, 37W and 37N is made up of an acoustic wave element.

The high frequency circuit further comprises the power amplifiers 21G and 21D, the couplers 22G and 22D, the automatic power control circuits 23G and 23D, and the low-pass filters 24G and 24D that have configurations the same those of the second embodiment.

The high frequency circuit further comprises the band-pass filter 31W, the power amplifier 32W, the coupler 33W, the automatic power control circuit 34W and the isolator 35W that have configurations the same as those of the first embodiment. The high frequency circuit further comprises a band-pass filter 31N for the N-CDMA, a power amplifier 32N, a coupler 33N, an automatic power control circuit 34N and an isolator 35N that have configurations the same as the band-pass filter 31W, the power amplifier 32W, the coupler 33W, the automatic power control circuit 34W and the isolator 35W. Each of the band-pass filters 31W and 31N is made up of an acoustic wave element.

The front end module 2C will now be described in detail. The front end module 2C comprises a diplexer 11C, high frequency switches 16, 17, 12G and 12D and duplexers 13W and 13N. The diplexer 11C has first to third ports. The first port is connected to the antenna 1. The second port is designed to receive and output N-CDMA signals and GSM signals. The third port is designed to receive and output W-CDMA signals and DCS signals.

The second port of the diplexer 11C is connected to a movable contact of the high frequency switch 17. One of two fixed contacts of the high frequency switch 17 is connected to the duplexer 13N. The other one of the fixed contacts of the high frequency switch 17 is connected to the movable contact of the high frequency switch 12G. One (the one indicated with R) of the two fixed contacts of the high frequency switch 12G is connected to the input of the band-pass filter 25G. The other one (the one indicated with T) of the fixed contacts of the high frequency switch 12G is connected to the output of the low-pass filter 24G.

The third port of the diplexer 11C is connected to the movable contact of the high frequency switch 16. One of the two fixed contacts of the high frequency switch 16 is connected to the duplexer 13W. The other one of the fixed contacts of the high frequency switch 16 is connected to the movable contact of the high frequency switch 12D. One (the one indicated with R) of the two fixed contacts of the high frequency switch 12D is connected to the input of the band-pass filter 25D. The other one (the one indicated with T) of the fixed contacts of the high frequency switch 12D is connected to the output of the low-pass filter 24D.

The duplexer 13N has a common terminal, a reception terminal (the one indicated with R) and a transmission terminal (the one indicated with T). The common terminal of the duplexer 13N is connected to one of the fixed contacts of the high frequency switch 17. The reception terminal of the duplexer 13N is connected to the input of the low-noise amplifier 36N. The transmission terminal of the duplexer 13N is connected to the output of the isolator 35N.

The duplexer 13W has the common terminal, the reception terminal (the one indicated with R) and the transmission terminal (the one indicated with T). The common terminal of the duplexer 13W is connected to one of the fixed contacts of the high frequency switch 16. The reception terminal of the duplexer 13W is connected to the input of the low-noise amplifier 36W. The transmission terminal of the duplexer 13W is connected to the output of the isolator 35W.

The diplexer 11C separates the signals of the N-CDMA and the GSM from the signals of the W-CDMA and the DCS, according to the frequencies of the signals. To be specific, the diplexer 11C outputs from the first port the N-CDMA transmission signals or the GSM transmission signals inputted to the second port and the W-CDMA transmission signals or the DCS transmission signals inputted to the third port. The diplexer 11C outputs from the second port the N-CDMA reception signals or the GSM reception signals inputted to the first port, and outputs from the third port the W-CDMA reception signals or the DCS reception signals inputted to the first port. The diplexer 11C has a configuration the same as that of the diplexer 11A of the first embodiment.

The high frequency switch 17 separates N-CDMA transmission signals and reception signals from GSM transmission signals and reception signals. To be specific, the high frequency switch 17 outputs from the movable contact the N-CDMA transmission signals inputted to one of the fixed contacts, and outputs from the one of the fixed contacts the N-CDMA reception signals inputted to the movable contact. The high frequency switch 17 outputs from the movable contact the GSM transmission signals inputted to the other one of the fixed contacts, and outputs from the other one of the fixed contacts the GSM reception signals inputted to the movable contact. The high frequency switch 17 has a configuration the same as that of the high frequency switch 12G.

The high frequency switch 16 separates W-CDMA transmission signals and reception signals from DCS transmission signals and reception signals. The specific operation of the high frequency switch 16 is the same as that of the second embodiment and omitted here. The diplexer 11C and the high frequency switches 16 and 17 correspond to the first separating means of the invention.

The high frequency switch 12G separates GSM transmission signals and GSM reception signals from each other. The specific operation of the high frequency switch 12G is the same as that of the first embodiment and omitted here. The high frequency switch 12G corresponds to the second separating means of the invention.

The high frequency switch 12D separates DCS transmission signals and DCS reception signals from each other. The specific operation of the high frequency switch 12D is the same as that of the second embodiment and omitted here. The high frequency switch 12D corresponds to the third separating means of the invention.

The duplexer 13W separates W-CDMA transmission signals and W-CDMA reception signals from each other. The specific operation of the duplexer 13W is the same as that of the first embodiment and omitted here. The duplexer 13W corresponds to the first duplexer of the invention.

The duplexer 13N separates N-CDMA transmission signals and N-CDMA reception signals from each other. To be specific, the duplexer 13N outputs from the reception terminal the N-CDMA reception signals (indicated as NCDMA/RX in the drawings) inputted to the common terminal, and outputs from the common terminal the N-CDMA transmission signals (indicated as NCDMA/TX in the drawings) inputted to the transmission terminal. The duplexer 13N has a configuration the same as that of the duplexer 13W. The duplexer 13N corresponds to the second duplexer of the invention.

The integrated circuit 3C will now be described. The integrated circuit 3C receives an input signal of the baseband made up of an I signal and a Q signal, and outputs an output signal of the baseband made up of an I signal and a Q signal.

The integrated circuit 3C comprises: the mixer 42G having the input connected to the output of the band-pass filter 25G; the amplifier 43G having the input connected to the output of the mixer 42G; the mixer 42D having the input connected to the output of the band-pass filter 25D; and the amplifier 43D having the input connected to the output of the mixer 42D. The integrated circuit 3C further comprises: the mixer 42W having the input connected to the output of the band-pass filter 37W; the amplifier 43W having the input connected to the output of the mixer 42W; a mixer 42N having an input connected to the output of the band-pass filter 37N; and an amplifier 43N having an input connected to an output of the mixer 42N.

The integrated circuit 3C further comprises: the mixer 41 having the output connected to the inputs of the power amplifiers 21G and 21D; the mixer 41W having the output connected to the input of the band-pass filter 31W; and a mixer 41N having an output connected to an input of the band-pass filter 31N. The mixers 42G and 42D are connected to the voltage controlled oscillator 5. The mixer 42W is connected to the voltage controlled oscillator 6W. The mixer 41 is connected to the voltage controlled oscillator 4. The mixer 41W is connected to the voltage controlled oscillator 6W. The mixer 41N is connected to the voltage controlled oscillator 6N.

The integrated circuit 3C further comprises the phase-locked loop circuit 44 for the GSM and the DCS, the phase-locked loop circuit 45W for the W-CDMA, and a phase-locked loop circuit 45N for the N-CDMA. The phase-locked loop circuit 44 is connected to the voltage controlled oscillators 4 and 5. The phase-locked loop circuit 45W is connected to the voltage controlled oscillator 6W. The phase-locked loop circuit 45N is connected to the voltage controlled oscillator 6N.

The mixer 42G mixes an output signal of the band-pass filter 25G with a high frequency signal outputted from the voltage controlled oscillator 5G, and thereby converts the high-frequency reception signal to a baseband signal. The mixer 42D mixes an output signal of the band-pass filter 25D with a high frequency signal outputted from the voltage controlled oscillator 5, and thereby converts the high-frequency reception signal to a baseband signal. The mixer 42W mixes an output signal of the band-pass filter 37W with a high frequency signal outputted from the voltage controlled oscillator 6W, and thereby converts the high-frequency reception signal to a baseband signal. The mixer 42N mixes an output signal of the band-pass filter 37N with a high frequency signal outputted from the voltage controlled oscillator 6N, and thereby converts the high-frequency reception signal to a baseband signal.

The mixer 41 mixes a baseband signal inputted to the integrated circuit 3C with a high frequency signal outputted from the voltage controlled oscillator 4, and thereby converts the baseband signal to a high-frequency transmission signal. The mixer 41W mixes a baseband signal inputted to the integrated circuit 3C with a high frequency signal outputted from the voltage controlled oscillator 6W, and thereby converts the baseband signal to a high-frequency transmission signal. The mixer 41N mixes a baseband signal inputted to the integrated circuit 3C with a high frequency signal outputted from the voltage controlled oscillator 6N, and thereby converts the baseband signal to a high-frequency transmission signal.

Although not shown, the integrated circuit 3C further comprises: a function of quadrature-modulating the received I signal and Q signal and sending the modulated signal to the mixers 41, 41W and 41N; and a function of generating an I signal and a Q signal by quadrature-demodulating the output signals of the amplifiers 43G, 43D, 43W and the 43N, and outputting the I signal and Q signal. It is possible that the mixers 41, 41W and 41N also have a function of quadrature modulation or the mixers 42G, 42D, 42W and 42N also have a function of quadrature demodulation.

A GSM reception signal outputted from the high frequency switch 12G passes through the band-pass filter 25G and is inputted to the mixer 42G. A DCS reception signal outputted from the high frequency switch 12D passes through the band-pass filter 25D and is inputted to the mixer 42D. A W-CDMA reception signal outputted from the duplexer 13W passes through the low-noise amplifier 36W and the band-pass filter 37W and is inputted to the mixer 42W. An N-CDMA reception signal outputted from the duplexer 13N passes through the low-noise amplifier 36N and the band-pass filter 37N and is inputted to the mixer 42N.

An output signal of the mixer 41 passes through the power amplifier 21G, the coupler 22G and the low-pass filter 24G and is inputted to the high frequency switch 12G. In addition, an output signal of the mixer 41 passes through the power amplifier 21D, the coupler 22D and the low-pass filter 24D and is inputted to the high frequency switch 12D. An output signal of the mixer 41W passes through the band-pass filter 31W, the power amplifier 32W, the coupler 33W and the isolator 35W and is inputted to the duplexer 13W. An output signal of the mixer 41N passes through the band-pass filter 31N, the power amplifier 32N, the coupler 33N and the isolator 35N and is inputted to the duplexer 13N.

The structure of the front end module 2C will now be described. The front end module 2C comprises the single multi-layer substrate 20 for integration of the diplexer 11C, the high frequency switches 16, 17, 12G and 12D and the duplexers 13W and 13N. The basic structure of the multi-layer substrate 20 is the same as that of the first embodiment. The structure of each of the duplexers 13W and 13N of the third embodiment may be any of the first to third examples shown in FIG. 9 to FIG. 11 as the first embodiment. In the third embodiment the two acoustic wave elements that the duplexer 13W includes correspond to the first acoustic wave elements of the invention. The two acoustic wave elements that the duplexer 13N includes correspond to the second acoustic wave elements of the invention. Accordingly, the chip including the acoustic wave elements that the duplexer 13W includes corresponds to the first chip of the invention. The chip including the acoustic wave elements that the duplexer 13N includes corresponds to the second chip of the invention. The mounting board 53 or 56 on which the chip including the acoustic wave elements that the duplexer 13W includes is mounted corresponds to the first mounting board of the invention. The mounting board 53 or 56 on which the chip including the acoustic wave elements that the duplexer 13N includes is mounted corresponds to the second mounting board of the invention.

According to the front end module 2C of the embodiment as thus described, the single multi-layer substrate 20 is used to integrate the diplexer 11C, the high frequency switches 16, 17, 12G and 12D and the duplexer 13W including the two acoustic wave elements, and the duplexer 13N including the two acoustic wave elements. As a result, according to the embodiment, it is possible to implement the front end module 2C that is operable in the two types of time division multiple access systems (the GSM and the DCS) and the two types of code division multiple access systems (the W-CDMA and the N-CDMA), and easily achieves a reduction in size and weight, and higher combination and integration of components.

The remainder of configuration, operation and effects of the third embodiment are similar to those of the first embodiment. In the third embodiment the high frequency switch 14 of FIG. 12 may be used in place of the diplexer 11C, the duplexer 15 of FIG. 12 may be used in place of the high frequency switch 12G, and the duplexer 15 of FIG. 12 may be used in place of the high frequency switch 12D.

Two modification examples of the front end module 2C of the third embodiment will now be described.

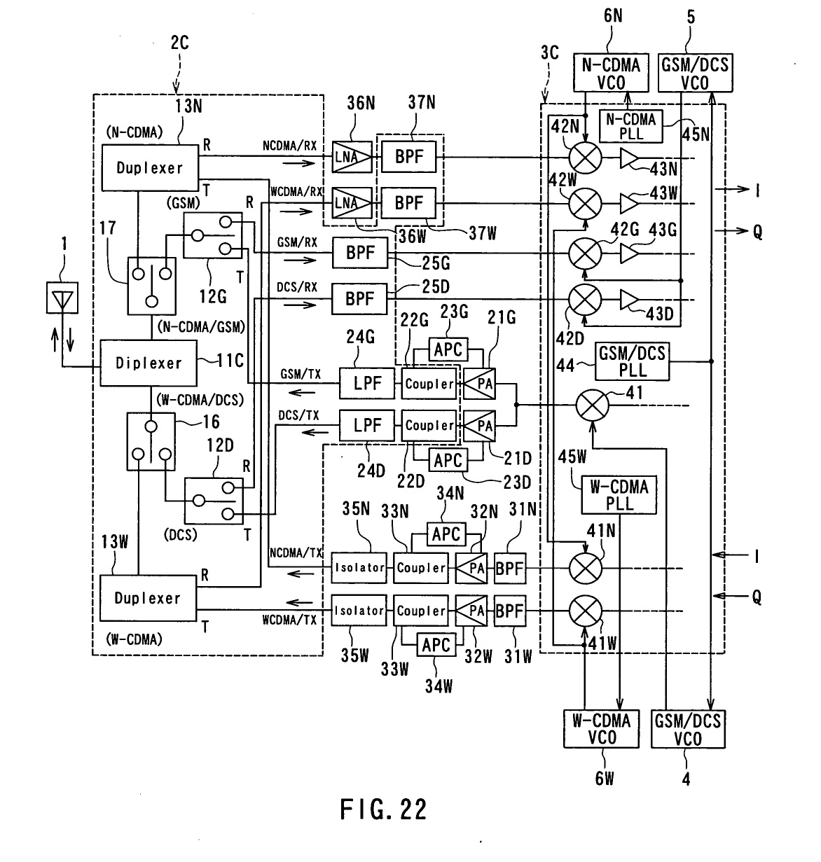

FIG. 22 is a block diagram illustrating a high frequency circuit of a cellular phone including the front end module 2C of the first modification example. In addition to the components of the front end module 2C shown in FIG. 21, the front end module 2C of the first modification example comprises: the coupler 22G and the low-pass filter 24G for allowing GSM transmission signals to pass therethrough; the coupler 22D and the low-pass filter 24D for allowing DCS transmission signals to pass therethrough; the band-pass filter 25G for allowing GSM reception signals to pass therethrough; the band-pass filter 25D for allowing DCS reception signals to pass therethrough; the band-pass filter 37W for allowing W-CDMA reception signals to pass therethrough; and the band-pass filter 37N for allowing N-CDMA reception signals to pass therethrough. In the first modification example the multi-layer substrate 20 is used to integrate the above-mentioned additional components, too, in addition to the components of the front end module 2C shown in FIG. 21.

The remainder of configuration of the front end module 2C of the first modification example is the same as that of the front end module 2C shown in FIG. 21. According to the first modification example, it is possible to optimize the characteristic of the front end module 2C as a whole including the above-mentioned additional components of the front end module 2C.

In the front end module 2C of the first modification example the high frequency switch 14 may be used in place of the diplexer 11C, the duplexer 15 may be used in place of the high frequency switch 12G, and the duplexer 15 may be used in place of the high frequency switch 12D.

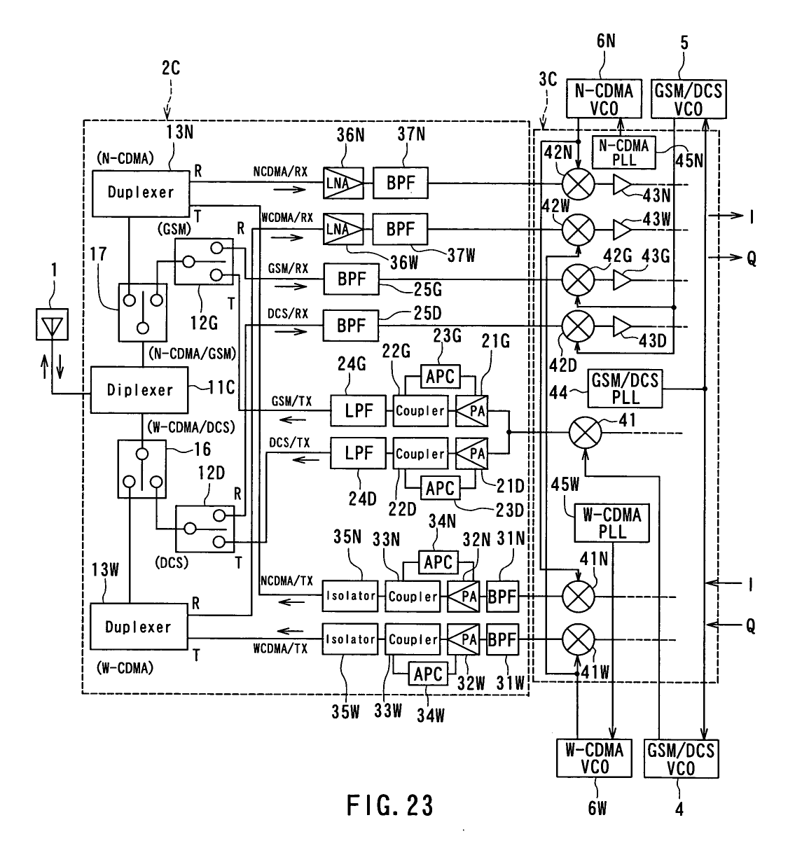

FIG. 23 is a block diagram illustrating a high frequency circuit of a cellular phone including the front end module 2C of the second modification example. In addition to the components of the front end module 2C shown in FIG. 21, the front end module 2C of the second modification example comprises the power amplifiers 21G and 21D, the couplers 22G and 22D, the automatic power control circuits 23G and 23D, the low-pass filters 24G and 24D, the band-pass filters 25G and 25D, the band-pass filters 31W and 31N, the power amplifiers 32W and 32N, the couplers 33W and 33N, the automatic power control circuits 34W and 34N, the isolators 35W and 35N, the low-noise amplifiers 36W and 36N, and the band-pass filters 37W and 37N. In the second modification example the multi-layer substrate 20 is used to integrate the above-mentioned additional components, too, in addition to the components of the front end module 2C shown in FIG. 21.

The remainder of configuration of the front end module 2C of the second modification example is the same as that of the front end module 2C shown in FIG. 21. According to the second modification example, it is possible to optimize the characteristic of the front end module 2C as a whole including the above-mentioned additional components of the front end module 2C.

In the front end module 2C of the second modification example the high frequency switch 14 may be used in place of the diplexer 11C, the duplexer 15 may be used in place of the high frequency switch 12G, and the duplexer 15 may be used in place of the high frequency switch 12D.

[Fourth Embodiment]

A front end module of a fourth embodiment of the invention will now be described. The front end module of the fourth embodiment is made up of the front end module of any of the first to third embodiments that further comprises the antenna 1. In the fourth embodiment the multi-layer substrate 20 is used to integrate the antenna 1, too, in addition to the components of any of the first to third embodiments.

Two examples of the structure of the antenna 1 of the fourth embodiment will now be described. Among antennas of various types and structures known as the antennas used for cellular phones, a patch antenna is used as the antenna 1 of the embodiment.

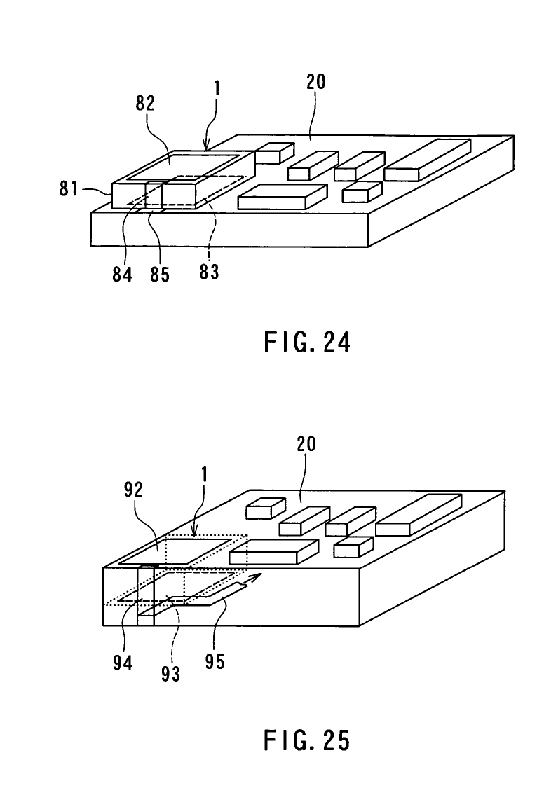

FIG. 24 is a perspective view illustrating the first example of the structure of the antenna 1. In the first example the antenna 1 is fabricated separately from the multi-layer substrate 20 and mounted on the multi-layer substrate 20 by soldering, for example. The antenna 1 of the first example comprises: a dielectric section 81 made of a dielectric and having the shape of a rectangular solid; an electrode 82 provided on the top surface of the dielectric section 81; a conductor layer 83 provided on the bottom surface of the dielectric section 81 and forming a ground surface; and a conductor section 84 for feeding provided on a side of the dielectric section 81. Each of the electrode 82 and the conductor layer 83 has the shape of a rectangular flat plate. An upper end portion of the conductor section 84 faces toward a side of the electrode 82 with a specific space. A conductor layer 85 connected to a lower end portion of the conductor section 84 is provided on the top surface of the multi-layer substrate 20.

FIG. 25 is a perspective view illustrating the second example of the structure of the antenna 1. In the second example the antenna 1 is incorporated in the multi-layer substrate 20. The antenna 1 of the second example comprises: an electrode 92 provided on the top surface of the multi-layer substrate 20; a conductor layer 93 that is provided in a region inside the multi-layer substrate 20 facing toward the electrode 92 and forms a ground surface; and a conductor section 94 for feeding provided on a side of the the multi-layer substrate 20. Each of the electrode 92 and the conductor layer 93 has the shape of a rectangular flat plate. An upper end portion of the conductor section 94 faces toward a side of the electrode 92 with a specific space. A conductor layer 95 connected to a lower end portion of the conductor section 94 is provided in a region inside the multi-layer substrate 20 located lower than the conductor layer 93.

According to the fourth embodiment, it is possible to optimize the characteristic of the front end module as a whole including the antenna 1. The remainder of configuration, operation and effects of the fourth embodiment are similar to those of any of the first to third embodiments including the modification examples.

[Fifth Embodiment]

A front end module of a fifth embodiment of the invention will now be described. The front end module of the embodiment is a module that is operable in the GSM as a time division multiple access system and the W-CDMA as a code division multiple access system and that performs processing of transmission signals and reception signals of these systems. The frequency band of transmission signals and the frequency band of reception signals of the GSM and the frequency band of transmission signals and the frequency band of reception signals of the W-CDMA are the same as those of the first embodiment.

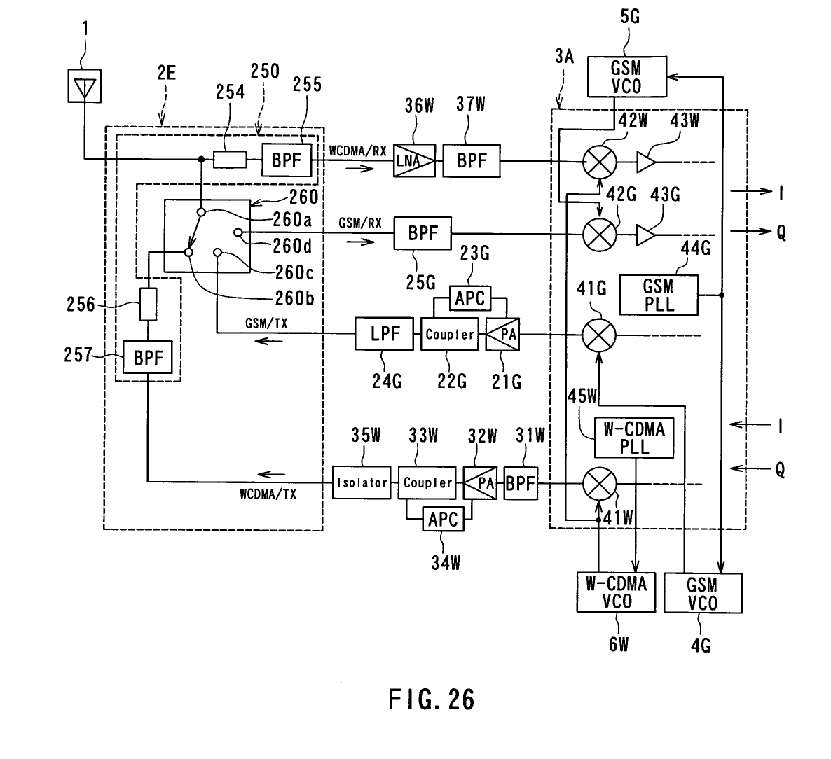

Reference is now made to FIG. 26 to describe an example of a high frequency circuit of a cellular phone including the front end module of the fifth embodiment. The high frequency circuit of FIG. 26 comprises the antenna 1 and the front end module 2E of the embodiment connected to the antenna 1. The configuration of the remainder of the high frequency circuit of FIG. 26 is the same as that of the high frequency circuit of the first embodiment except the antenna 1 and the front end module 2A.

The front end module 2E will now be described in detail. The front end module 2E comprises a duplexer 250 and a high frequency switch 260. The high frequency switch 260 has a movable contact 260a, and three fixed contacts 260b, 260c and 260d. The movable contact 260a is connected to the antenna 1. The fixed contact 260b is connected to an end of a transmission-side delay line 256 that will be described later. The fixed contact 260c is connected to the output of the low-pass filter 24G. The fixed contact 260d is connected to the input of the band-pass filter 25G.

The duplexer 250 has a reception-side delay line 254 having an end connected to the antenna 1, and a reception-side band-pass filter (indicated as BPF in FIG. 26) 255 having an input connected to the other end of the delay line 254 and an output connected to the input of the low-noise amplifier 36W. The duplexer 250 further has a transmission-side delay line 256 having an end connected to the fixed contact 260b of the high frequency switch 260, and a transmission-side band-pass filter (indicated as BPF in FIG. 26) 257 having an output connected to the other end of the delay line 256 and an input connected to the output of the isolator 35W. Each of the band-pass filters 255 and 257 is made up of an acoustic wave element. The operations of the delay lines 254 and 256 are the same as those of the delay lines 154 and 156 of the first embodiment. The configurations and operations of the band-pass filters 255 and 257 are the same as those of the band-pass filters 155 and 157 of the first embodiment.

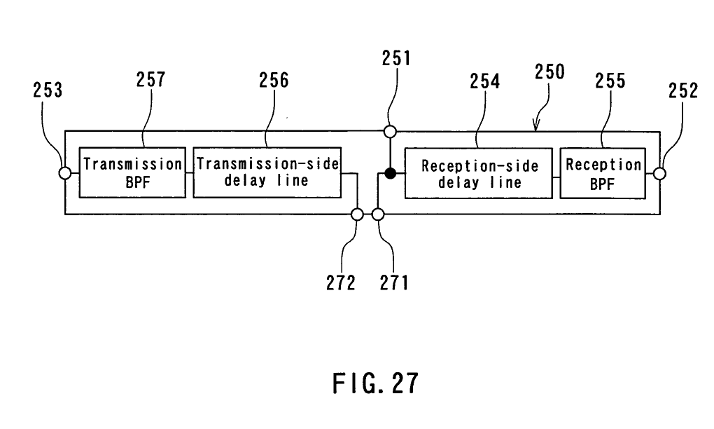

FIG. 27 is a block diagram illustrating the duplexer 250 of FIG. 26. In addition to the delay lines 254 and 256 and the band-pass filters 255 and 257 described above, the duplexer 250 has an antenna terminal 251, a reception terminal 252, a transmission terminal 253 and terminals 271 and 272. The antenna terminal 251 is connected to an end of the reception-side delay line 254. The antenna terminal 251 is designed to be connected to the antenna 1. The reception terminal 252 is connected to the output of the reception-side band-pass filter (indicated as reception BPF in FIG. 27) 255. The reception terminal 252 is designed to be connected to the input of the low-noise amplifier 36W. The transmission terminal 253 is connected to the input of the transmission-side band-pass filter (indicated as transmission BPF in FIG. 27) 257. The transmission terminal 253 is designed to be connected to the output of the isolator 35W. The terminal 271 is connected to an end of the reception-side delay line 254. The terminal 271 is designed to be connected to the movable contact 260a of the high frequency switch 260. The terminal 272 is connected to an end of the transmission-side delay line 256. The terminal 272 is designed to be connected to the movable contact 260b of the high frequency switch 260.

According to the fifth embodiment, as shown in FIG. 26 and FIG. 27, an end of the reception-side delay line 254 is connected to the antenna 1 at any time. On the other hand, an end of the transmission-side delay line 256 is connected to the antenna 1 only when the movable contact 260a and the fixed contact 260b of the high frequency switch 260 are connected to each other. The duplexer 250 of FIG. 27 has a configuration the same as that of the duplexer 13W of FIG. 4 when the movable contact 260a and the fixed contact 260b of the high frequency switch 260 are connected to each other. The duplexer of the invention includes the one having a configuration shown in FIG. 27.

Alternatively, as the circuit configuration shown in FIG. 5, a matching circuit for performing impedance matching between the duplexer 250 and an external circuit may be provided between each of the antenna terminal 251, the reception terminal 252 and the transmission terminal 253 of the duplexer 250 of FIG. 27 and the external circuit connected thereto.

The operation of the front end module 2E of the embodiment will now be described. The front end module 2E is capable of receiving W-CDMA reception signals (indicated as WCDMA/RX in FIG. 26) at any time. Therefore, if data signals are W-CDMA reception signals, the front end module 2E is capable of receiving data at any time. Furthermore, the front end module 2E is capable of making a call through the use of GSM signals while receiving W-CDMA reception signals at any time. That is, if the movable contact 260a of the high frequency switch 260 is connected to the fixed contact 260c, the front end module 2E is capable of sending GSM transmission signals (indicated as GSM/TX in FIG. 26) to the antenna 1. If the movable contact 260a is connected to the fixed contact 260d, the front end module 2E is capable of sending GSM reception signals (indicated as GSM/RX in FIG. 26) to the band-pass filter 25G. If the movable contact 260a is connected to the fixed contact 260b, the front end module 2E is capable of sending W-CDMA transmission signals (indicated as WCDMA/TX in FIG. 26) to the antenna 1.

The structure of the front end module 2E will now be described. The front end module 2E comprises the single multi-layer substrate 20 for integration of the duplexer 250 and the high frequency switch 260. The basic structure of the multi-layer substrate 20 is the same as that of the first embodiment. The structure of the duplexer 250 of the fifth embodiment may be any of the first to third examples shown in FIG. 9 to FIG. 11 as the first embodiment.

According to the fifth embodiment, as the second modification example of the first embodiment, the front end module 2E may comprise: the coupler 22G and the low-pass filter 24G for allowing GSM transmission signals to pass therethrough; the band-pass filter 25G for allowing GSM reception signals to pass therethrough; and the band-pass filter 37W for allowing W-CDMA reception signals to pass therethrough, in addition to the components of the front end module 2E shown in FIG. 26. In this case, the multi-layer substrate 20 is used to integrate the above-mentioned additional components, too, in addition to the components of the front end module 2E shown in FIG. 26.

According to the fifth embodiment, as the third modification example of the first embodiment, the front end module 2E may comprise the power amplifier 21G, the coupler 22G, the automatic power control circuit 23G, the low-pass filter 24G, the band-pass filter 25G, the band-pass filter 31W, the power amplifier 32W, the coupler 33W, the automatic power control circuit 34W, the isolator 35W, the low-noise amplifier 36W and the band-pass filter 37W, in addition to the components of the front end module 2E shown in FIG. 26. In this case, the multi-layer substrate 20 is used to integrate the above-mentioned additional components, too, in addition to the components of the front end module 2E shown in FIG. 26.

According to the fifth embodiment, the front end module 2E may further comprise the antenna 1, as the fourth embodiment. In this case, the multi-layer substrate 20 is used to integrate the antenna 1, too, in addition to the components of the front end module 2E shown in FIG. 26.

The remainder of configuration, operation and effects of the fifth embodiment are similar to those of the first embodiment.

The present invention is not limited to the foregoing embodiments but may be practiced in still other ways. For example, the time division multiple access system of the invention is not limited to the GSM and the DCS employed in the embodiments but may be any other system. The code division multiple access system of the invention is not limited to the W-CDMA and the N-CDMA employed in the embodiments but may be any other system.

According to the descriptions of the embodiments, the chip including the acoustic wave elements used in the reception-side band-pass filter of the duplexer is separated from the chip including the acoustic wave elements used in the transmission-side band-pass filter of the duplexer. However, it is needless to say that a configuration similar to the ones disclosed in the foregoing embodiments is implemented even if the two chips are combined to form a single chip. The invention includes such a case in which the acoustic wave elements used in the reception-side band-pass filter of the duplexer and the acoustic wave elements used in the transmission-side band-pass filter of the duplexer are provided in a single chip.

According to the first front end module of the invention thus described, the single multi-layer substrate for integration is used to integrate the first separating means, the second separating means, and the duplexer including the two acoustic wave elements. As a result, according to the invention, it is possible to implement the front end module that is operable in the time division multiple access system and the code division multiple access system and easily achieves a reduction in size and weight, and higher combination and integration of components.

According to the first front end module of the invention, the duplexer may incorporate the chip including the acoustic wave elements and mounted on the multi-layer substrate, and the multi-layer substrate may include the components of the duplexer except the acoustic wave elements. In this case, it is possible to reduce the thickness of the front end module.

According to the first front end module of the invention, the duplexer may incorporate the chip including the acoustic wave elements and the mounting board on which the chip is mounted, the chip and the mounting board may be mounted on the multi-layer substrate, and the multi-layer substrate may include the components of the duplexer except the acoustic wave elements. In this case, it is possible to reduce the thickness of the front end module and to improve the yield of the front end module.

According to the second front end module of the invention, the single multi-layer substrate for integration is used to integrate the first separating means, the second separating means, the third separating means, and the duplexer including the two acoustic wave elements. As a result, according to the invention, it is possible to implement the front end module that is operable in two types of the time division multiple access system and one type of the code division multiple access system and easily achieves a reduction in size and weight, and higher combination and integration of components.

According to the second front end module of the invention, the duplexer may incorporate the chip including the acoustic wave elements and mounted on the multi-layer substrate, and the multi-layer substrate may include the components of the duplexer except the acoustic wave elements. In this case, it is possible to reduce the thickness of the front end module.

According to the second front end module of the invention, the duplexer may incorporate the chip including the acoustic wave elements and the mounting board on which the chip is mounted, the chip and the mounting board may be mounted on the multi-layer substrate, and the multi-layer substrate may include the components of the duplexer except the acoustic wave elements. In this case, it is possible to reduce the thickness of the front end module and to improve the yield of the front end module.

According to the third front end module of the invention, the single multi-layer substrate for integration is used to integrate the first separating means, the second separating means, the third separating means, the first duplexer including the two first acoustic wave elements, and the second duplexer including the two second acoustic wave elements. As a result, according to the invention, it is possible to implement the front end module that is operable in two types of the time division multiple access system and two types of the code division multiple access system and easily achieves a reduction in size and weight, and higher combination and integration of components.

According to the third front end module of the invention, the first duplexer may incorporate the first chip including the first acoustic wave elements and mounted on the multi-layer substrate, the second duplexer may incorporate the second chip including the second acoustic wave elements and mounted on the multi-layer substrate, and the multi-layer substrate may include the components of the first duplexer except the first acoustic wave elements and the components of the second duplexer except the second acoustic wave elements. In this case, it is possible to reduce the thickness of the front end module.

According to the third front end module of the invention, the first duplexer may incorporate the first chip including the first acoustic wave elements and the first mounting board on which the first chip is mounted, and the first chip and the first mounting board may be mounted on the multi-layer substrate. In addition, the second duplexer may incorporate the second chip including the second acoustic wave elements and the second mounting board on which the second chip is mounted, and the second chip and the second mounting board may be mounted on the multi-layer substrate. Furthermore, the multi-layer substrate may include the components of the first duplexer except the first acoustic wave elements and the components of the second duplexer except the second acoustic wave elements. In this case, it is possible to reduce the thickness of the front end module and to improve the yield of the front end module.

According to the first high frequency functional module of the invention, the duplexer incorporates the chip including the acoustic wave elements and mounted on the multi-layer substrate, and the multi-layer substrate includes the components of the duplexer except the acoustic wave elements and at least part of the circuit connected to the duplexer. As a result, according to the invention, it is possible to implement the high frequency functional module that easily achieves a reduction in size and weight and higher combination and integration of components, and that is capable of reducing the thickness, in particular.

According to the second high frequency functional module of the invention, the duplexer incorporates the chip including the acoustic wave elements and the mounting board on which the chip is mounted, and the chip and the mounting board are mounted on the multi-layer substrate. The multi-layer substrate includes the components of the duplexer except the acoustic wave elements and at least part of the circuit connected to the duplexer. As a result, according to the invention, it is possible to implement the high frequency functional module that easily achieves a reduction in size and weight and higher combination and integration of components, and that is capable of reducing the thickness and improving the yield, in particular.

Obviously many modifications and variations of the present invention are possible in the light of the above teachings. It is therefore to be understood that within the scope of the appended claims the invention may be practiced otherwise than as specifically described.

What is claimed is:

1. A front end module for processing transmission signals and reception signals of a time division multiple access system and transmission signals and reception signals of a code division multiple access system, the front end module comprising:
a first separating means connected to an antenna and separating the transmission signals and the reception signals of the time division multiple access system from the transmission signals and the reception signals of the code division multiple access system;
a second separating means connected to the first separating means and separating the transmission signals of the time division multiple access system from the reception signals of the time division multiple access system;
a duplexer connected to the first separating means, including two acoustic wave elements each of which functions as a filter, and separating the transmission signals of the code division multiple access system from the reception signals of the code division multiple access system; and
a single multi-layer substrate for integrating the first separating means, the second separating means and the duplexer.

2. The front end module according to claim 1, further comprising:
a filter connected to the second separating means and allowing the transmission signals of the time division multiple access system to pass through this filter;
a filter connected to the second separating means and allowing the reception signals of the time division multiple access system to pass through this filter; and
a filter connected to the duplexer and allowing the reception signals of the code division multiple access system to pass through this filter, wherein
the multi-layer substrate is used to further integrate the filters.

3. The front end module according to claim 1, further comprising a power amplifier for amplifying the transmission signals of the time division multiple access system and a power amplifier for amplifying the transmission signals of the code division multiple access system, wherein
the multi-layer substrate is used to further integrate the power amplifiers.

4. The front end module according to claim 1, further comprising the antenna, wherein the multi-layer substrate is used to further integrate the antenna.

5. The front end module according to claim 1, wherein: the duplexer incorporates a chip or two chips including the acoustic wave elements and a mounting board on which the chip or chips are mounted; the mounting board includes components of the duplexer except the acoustic wave elements; and the duplexer is mounted on the multi-layer substrate.

6. The front end module according to claim 1, wherein the duplexer incorporates a chip or two chips including the acoustic wave elements and mounted on the multi-layer substrate, and the multi-layer substrate includes components of the duplexer except the acoustic wave elements.

7. The front end module according to claim 1, wherein: the duplexer incorporates a chip or two chips including the acoustic wave elements and a mounting board or two mounting boards on which the chip or chips are mounted; the chip or chips and the mounting board or boards are mounted on the multi-layer substrate; and the multi-layer substrate includes components of the duplexer except the acoustic wave elements.

8. A front end module for processing first transmission signals and first reception signals of a time division multiple access system included in a first frequency band, second transmission signals and second reception signals of a time division multiple access system included in a second frequency band, and third transmission signals and third reception signals of a code division multiple access system included in a third frequency band, the front end module comprising:
a first separating means connected to an antenna and separating the first transmission signals and the first reception signals, the second transmission signals and the second reception signals, and the third transmission signals and the third reception signals from one another;
a second separating means connected to the first separating means and separating the first transmission signals from the first reception signals;
a third separating means connected to the first separating means and separating the second transmission signals from the second reception signals;
a duplexer connected to the first separating means, including two acoustic wave elements each of which functions as a filter, and separating the third transmission signals from the third reception signals; and
a single multi-layer substrate for integrating the first separating means, the second separating means, the third separating means and the duplexer.

9. The front end module according to claim 8, further comprising:
a filter connected to the second separating means and allowing the first transmission signals to pass through this filter;
a filter connected to the second separating means and allowing the first reception signals to pass through this filter;
a filter connected to the third separating means and allowing the second transmission signals to pass through this filter;
a filter connected to the third separating means and allowing the second reception signals to pass through this filter; and
a filter connected to the duplexer and allowing the third reception signals to pass through this filter, wherein
the multi-layer substrate is used to further integrate the filters.

10. The front end module according to claim 8, further comprising a power amplifier for amplifying the first transmission signals, a power amplifier for amplifying the second transmission signals, and a power amplifier for amplifying the third transmission signals, wherein
the multi-layer substrate is used to further integrate the power amplifiers.

11. The front end module according to claim 8, further comprising the antenna, wherein the multi-layer substrate is used to further integrate the antenna.

12. The front end module according to claim 8, wherein: the duplexer incorporates a chip or two chips including the acoustic wave elements and a mounting board on which the chip or chips are mounted; the mounting board includes components of the duplexer except the acoustic wave elements; and the duplexer is mounted on the multi-layer substrate.

13. The front end module according to claim 8, wherein the duplexer incorporates a chip or two chips including the acoustic wave elements and mounted on the multi-layer substrate, and the multi-layer substrate includes components of the duplexer except the acoustic wave elements.

14. The front end module according to claim 8, wherein: the duplexer incorporates a chip or two chips including the acoustic wave elements and a mounting board or two mounting boards on which the chip or chips are mounted; the chip or chips and the mounting board or boards are mounted on the multi-layer substrate; and the multi-layer substrate includes components of the duplexer except the acoustic wave elements.

15. A front end module for processing first transmission signals and first reception signals of a time division multiple access system included in a first frequency band, second transmission signals and second reception signals of a time division multiple access system included in a second frequency band, third transmission signals and third reception signals of a code division multiple access system included in a third frequency band, and fourth transmission signals and fourth reception signals of a code division multiple access system included in a fourth frequency band, the front end module comprising:
a first separating means connected to an antenna and separating the first transmission signals and the first reception signals, the second transmission signals and the second reception signals, the third transmission signals and the third reception signals, and the fourth transmission signals and the fourth reception signals from one another;
a second separating means connected to the first separating means and separating the first transmission signals from the first reception signals;
a third separating means connected to the first separating means and separating the second transmission signals from the second reception signals;
a first duplexer connected to the first separating means, including two first acoustic wave elements each of which functions as a filter, and separating the third transmission signals from the third reception signals;
a second duplexer connected to the first separating means, including two second acoustic wave elements each of which functions as a filter, and separating the fourth transmission signals from the fourth reception signals; and
a single multi-layer substrate for integrating the first separating means, the second separating means, the third separating means, the first duplexer and the second duplexer.

16. The front end module according to claim 15, further comprising:
a filter connected to the second separating means and allowing the first transmission signals to pass through this filter;
a filter connected to the second separating means and allowing the first reception signals to pass through this filter;
a filter connected to the third separating means and allowing the second transmission signals to pass through this filter;
a filter connected to the third separating means and allowing the second reception signals to pass through this filter;
a filter connected to the first duplexer and allowing the third reception signals to pass through this filter; and
a filter connected to the second duplexer and allowing the fourth reception signals to pass through this filter, wherein
the multi-layer substrate is used to further integrate the filters.

17. The front end module according to claim 15, further comprising: a power amplifier for amplifying the first transmission signals; a power amplifier for amplifying the second transmission signals; a power amplifier for amplifying the third transmission signals; and a power amplifier for amplifying the fourth transmission signals, wherein
the multi-layer substrate is used to further integrate the power amplifiers.

18. The front end module according to claim 15, further comprising the antenna, wherein the multi-layer substrate is used to further integrate the antenna.

19. The front end module according to claim 15, wherein:
the first duplexer incorporates a first chip or two first chips including the first acoustic wave elements and a first mounting board on which the first chip or chips are mounted, and the first mounting board includes components of the first duplexer except the first acoustic wave elements;
the second duplexer incorporates a second chip or two second chips including the second acoustic wave elements and a second mounting board on which the second chip or chips are mounted, and the second mounting board includes components of the second duplexer except the second acoustic wave elements; and
the first and second duplexers are mounted on the multi-layer substrate.

20. The front end module according to claim 15, wherein:
the first duplexer incorporates a first chip or two first chips including the first acoustic wave elements and mounted on the multi-layer substrate;
the second duplexer incorporates a second chip or two second chips including the second acoustic wave elements and mounted on the multi-layer substrate; and
the multi-layer substrate includes components of the first duplexer except the first acoustic wave elements and components of the second duplexer except the second acoustic wave elements.

21. The front end module according to claim 15, wherein:
the first duplexer incorporates a first chip or two first chips including the first acoustic wave elements and a first mounting board or two first mounting boards on which the first chip or chips are mounted, and the first chip or chips and the first mounting board or boards are mounted on the multi-layer substrate;
the second duplexer incorporates a second chip or two second chips including the second acoustic wave elements and a second mounting board or two second mounting boards on which the second chip or chips are mounted, and the second chip or chips and the second mounting board or boards are mounted on the multi-layer substrate; and
the multi-layer substrate includes components of the first duplexer except the first acoustic wave elements and components of the second duplexer except the second acoustic wave elements.

22. A high frequency functional module comprising:
a duplexer including two acoustic wave elements each of which functions as a filter, and separating transmission signals from reception signals; and
a single multi-layer substrate for integrating the duplexer, wherein:
the duplexer incorporates a chip or two chips including the acoustic wave elements and mounted on the multi-layer substrate; and
the multi-layer substrate includes at least part of components of the duplexer except the acoustic wave elements, and/or at least part of a circuit connected to the duplexer.

23. A high frequency functional module comprising:
a duplexer including two acoustic wave elements each of which functions as a filter, and separating transmission signals from reception signals; and
a single multi-layer substrate for integrating the duplexer, wherein:
the duplexer incorporates a chip or two chips including the acoustic wave elements and a mounting board or two mounting boards on which the chip or chips are mounted;
the chip or chips and the mounting board or boards are mounted on the multi-layer substrate; and
the multi-layer substrate includes at least part of components of the duplexer except the acoustic wave elements, and/or at least part of a circuit connected to the duplexer.
